(19) United States
(12) Patent Application Publication
(10) Pub. No.: US 2024/0293999 A1
(43) Pub. Date: Sep. 5, 2024

(54) BOROSILICATE GLASS

(71) Applicant: AGC Inc., Tokyo (JP)

(72) Inventors: Takato KAJIHARA, Tokyo (JP); Shigeki SAWAMURA, Tokyo (JP)

(73) Assignee: AGC Inc., Tokyo (JP)

(21) Appl. No.: 18/646,873

(22) Filed: Apr. 26, 2024

Related U.S. Application Data
(63) Continuation of application No. PCT/JP2022/039577, filed on Oct. 24, 2022.

(30) Foreign Application Priority Data
Oct. 27, 2021 (JP) 2021-175915

(51) Int. Cl. B32B 17/10; B32B 1/00

(52) U.S. Cl. CPC B32B 17/10036; B32B 1/00; B32B 17/10119; B32B 17/10449; B32B 17/10889; B32B 2250/03; B32B 2250/40; B32B 2309/105; B32B 2315/08; B32B 2605/08

(57) ABSTRACT

A borosilicate glass includes: in mol % in terms of oxide, 70.0%≤SiO₂≤85.0%; 5.0%≤B₂O₃ ≤20.0%; 0.70%≤Al₂O₃≤10.0%; 0.0%≤Li₂O≤5.0%; 0.0%≤Na₂O≤10.0%; 0.0%≤K₂O≤5.0%; 0.0%≤MgO≤5.0%; 0.0%≤CaO≤5.0%; 0.0%≤SrO≤5.0%; and 0.10%≤Fe₂O₃≤1.0%, in which the borosilicate glass has a total amount of SiO₂, Al₂O₃, and B₂O₃ of 85.0% or more, the borosilicate glass is substantially free of BaO, PbO, and As₂O₃, and T_{b}−Tₐ>0 is satisfied.

### CROSS-REFERENCE TO RELATED APPLICATIONS

This is a bypass continuation of International Patent Application No. PCT/JP2022/039577, filed on Oct. 24, 2022, which claims priority to Japanese Patent Application No. 2021-175915, filed on Oct. 27, 2021. The contents of these applications are hereby incorporated by reference in their entireties.

### TECHNICAL FIELD

The present invention relates to a borosilicate glass, a bent glass, production methods therefor, a laminated glass, and a window glass for a vehicle. Specifically, the present invention relates to a borosilicate glass with which a bent glass having an excellent heat shielding property can be produced, a bent glass, production methods therefor, a laminated glass, and a window glass for a vehicle.

### BACKGROUND ART

In recent years, attempts have been made from various aspects to improve comfort of indoor spaces in automobiles and buildings and to reduce energy consumption. For example, as a window glass for a vehicle, energy consumption by an air conditioner can be reduced by preventing transfer of heat from the outside of a vehicle to the inside of the vehicle due to a temperature difference inside and outside the vehicle. Therefore, the window glass for a vehicle is required to have a high heat shielding property.

Examples of a window glass having a heat shielding property include a soda lime glass, which is used in a window glass for an automobile in the related art. In addition, an alkali borosilicate glass such as those described in Patent Literatures 1 to 3 are also one of the alternative candidates.

### CITATION LIST

### Patent Literature

Patent Literature 1: JPH04-280834A
Patent Literature 2: JPH04-285026A
Patent Literature 3: JPH07-109147A

### SUMMARY OF INVENTION

The inventors of the present invention have found that in the case where a glass has a specific composition and is bent at a predetermined temperature, with a borosilicate glass which has a reduced average transmittance of a light in a specific wavelength range, or a borosilicate glass which has a reduced maximum value of a scattering intensity by small-angle X-ray scattering measurement, a bent glass having an excellent heat shielding property can be produced.

Therefore, the present invention provides a novel borosilicate glass with which a bent glass having an excellent heat shielding property can be produced, a bent glass including the borosilicate glass, production methods therefor, a laminated glass, and a window glass for a vehicle.

A borosilicate glass according to an embodiment of the present invention contains:
in mol % in terms of oxide,
   70.0%≤SiO₂≤85.0%;
   5.0%≤B₂O₃≤20.0%;
   0.70%≤Al₂O₃≤10.0%;
   0.0%≤Li₂O≤5.0%;
   0.0%≤Na₂O≤10.0%;
   0.0%≤K₂O≤5.0%;
   0.0%≤MgO≤5.0%;
   0.0%≤CaO≤5.0%;
   0.0%≤SrO≤5.0%; and
   0.10%≤Fe₂O₃≤1.0%, in which
   the borosilicate glass has a total amount of SiO₂, Al₂O₃, and B₂O₃ of 85.0% or more,
   the borosilicate glass is substantially free of BaO, PbO, and As₂O₃, and
   T_{b}−Tₐ>0 is satisfied where T_{b} [%] is an average transmittance of a light having a wavelength of 900 nm to 1300 nm when the borosilicate glass is a flat glass and a thickness of the flat glass is converted to 1.50 mm, and Tₐ [%] is an average transmittance of the light having a wavelength of 900 nm to 1300 nm when the thickness is converted to 1.50 mm in a case where the flat glass is heated and bent at a temperature equal to or higher than a temperature T₁₂ at which a glass viscosity is 10¹² [dPa·s].

A borosilicate glass according to an embodiment of the present invention contains:
in mol % in terms of oxide,
   70.0%≤SiO₂≤85.0%;
   5.0%≤B₂O₃≤20.0%;
   0.70%≤Al₂O₃≤10.0%;
   0.0%≤Li₂O≤5.0%;
   0.0%≤Na₂O≤10.0%;
   0.0%≤K₂O≤5.0%;
   0.0%≤MgO≤5.0%;
   0.0%≤CaO≤5.0%;
   0.0%≤SrO≤5.0%; and
   0.10%≤Fe₂O₃≤1.0%, in which
   the borosilicate glass has a total amount of SiO₂, Al₂O₃, and B₂O₃ of 85.0% or more,
   the borosilicate glass is substantially free of BaO, PbO, and As₂O₃, and
   T_{b}−Tₐ>0 is satisfied where T_{b} [%] is an average transmittance of a light having a wavelength of 900 nm to 1300 nm when the borosilicate glass is a flat glass and a thickness of the flat glass is converted to 1.50 mm, and Tₐ [%] is an average transmittance of the light having a wavelength of 900 nm to 1300 nm when the flat glass is heated to 630° C., a bending time is 6 minutes, and the thickness is converted to 1.50 mm.

A borosilicate glass according to an embodiment of the present invention contains:
in mol % in terms of oxide,
   70.0%≤SiO₂≤85.0%;
   5.0%≤B₂O₃≤20.0%;
   0.70%≤Al₂O₃≤10.0%;
   0.0%≤Li₂O≤5.0%;
   0.0%≤Na₂O≤10.0%;
   0.0%≤K₂O≤5.0%;
   0.0%≤MgO≤5.0%;
   0.0%≤CaO≤5.0%;
   0.0%≤SrO≤5.0%; and
   0.10%≤Fe₂O₃≤1.0%, in which
   the borosilicate glass has a total amount of SiO₂, Al₂O₃, and B₂O₃ of 85.0% or more,
   the borosilicate glass is substantially free of BaO, PbO, and As₂O₃,
   a maximum value of a normalized scattering intensity in a range of a scattering vector q of 0.10 to 2.0 (nm⁻¹) by small-angle X-ray scattering (SAXS) measurement is 0.35 or more when the borosilicate glass is a flat glass, and
   the maximum value of the normalized scattering intensity in the range of the scattering vector q of 0.10 to 2.0 (nm⁻¹) by the SAXS measurement is reduced in a case where the flat glass is heated and bent at a temperature equal to or higher than a temperature T₁₂ at which a glass viscosity is 10¹² [dPa·s].

In a borosilicate glass according to one aspect of the present invention, (Tts1−Tts2)/Tts1≥0.002 may be satisfied, where
Tts1 is a total solar transmittance defined by ISO-13837:2008 convention A and measured at a wind speed of 4 m/s when the borosilicate glass is a flat glass and a thickness of the flat glass is converted to 1.50 mm, and
Tts2 is a total solar transmittance defined by ISO-13837:2008 convention A and measured at a wind speed of 4 m/s when the thickness is converted to 1.50 mm in a case where the flat glass is heated and bent at a temperature equal to or higher than the temperature T₁₂ at which a glass viscosity is 10¹² [dPa·s].

The borosilicate glass according to the aspect of the present invention may be a float glass.

The borosilicate glass according to the aspect of the present invention may be a fusion draw glass.

In the borosilicate glass according to the aspect of the present invention, the temperature T₁₂ at which the glass viscosity is 10¹² [dPa·s] may be 650° C. or lower.

The borosilicate glass according to the aspect of the present invention may be substantially free of Er₂O₃.

The borosilicate glass according to the aspect of the present invention may have a transmittance of a light having a wavelength of 500 nm of 78.0% or more when a thickness of the borosilicate glass is converted into 1.50 mm.

The borosilicate glass according to the aspect of the present invention may have a

transmittance of a light having a wavelength of 1000 nm of 90.0% or less when a thickness of the borosilicate glass is converted into 1.50 mm.

The borosilicate glass according to the aspect of the present invention may have an average transmittance of a light having a wavelength of 450 nm to 700 nm of 78.0% or more when a thickness of the borosilicate glass is converted into 1.50 mm.

The borosilicate glass according to the aspect of the present invention may have an average transmittance of a light having a wavelength of 900 nm to 1300 nm of 90.0% or less when a thickness of the borosilicate glass is converted into 1.50 mm.

In the borosilicate glass according to the aspect of the present invention, the content of Fe₂O₃ may be 0.15% or more in mol % in terms of oxide.

A bent glass according to an embodiment of the present invention includes the above borosilicate glass.

A bent glass according to one aspect of the present invention may be a single bent glass.

The bent glass according to the aspect of the present invention may be a multi-bent glass.

The bent glass according to the aspect of the present invention may have a minimum radius of curvature of 500 mm or more and 100,000 mm or less.

The bent glass according to the aspect of the present invention may have a total solar transmittance defined by ISO-13837:2008 convention A and measured at a wind speed of 4 m/s of 90% or less when a thickness the bent glass is converted into 1.50 mm.

A method for producing a bent glass according to an embodiment of the present invention includes heating the above borosilicate glass to form a bent glass.

A laminated glass according to an embodiment of the present invention includes: a first glass plate; a second glass plate; and an interlayer sandwiched between the first glass plate and the second glass plate, in which at least one of the first glass plate and the second glass plate is the above borosilicate glass.

In a laminated glass according to one aspect of the present invention, the first glass plate, the second glass plate, and the interlayer may have a total thickness of 6.00 mm or less, and the laminated glass may have a visible light transmittance Tv defined by ISO-9050:2003 using a D65 light source of 70% or more.

A window glass for a vehicle according to an embodiment of the present invention includes the above borosilicate glass or bent glass.

A window glass for a vehicle according to another embodiment of the present invention includes the above laminated glass.

With the borosilicate glass according to the embodiment of the present invention, a bent glass having an excellent heat shielding property can be produced. In addition, a bent glass, a laminated glass, and a window glass for a vehicle including the borosilicate glass have an excellent heat shielding property.

### BRIEF DESCRIPTION OF DRAWINGS

FIG. 1 is a cross-sectional view of an example of a laminated glass according to an embodiment of the present invention.

FIG. 2 is a conceptual diagram illustrating a state in which the laminated glass of the embodiment of the present invention is used as a window glass for an automobile.

FIG. 3 is an enlarged view of a portion S in FIG. 2.

FIG. 4 is a cross-sectional view taken along a line Y-Y in FIG. 3.

FIGS. 5A and 5B are graphs illustrating measurement results of transmission and reflection spectra of a light having a wavelength of 200 nm to 2500 nm before and after bending for a glass A and a glass D, respectively, in Examples.

FIG. 6 is a graph illustrating SAXS results before and after bending for the glass A and the glass E in Examples. The vertical axis means a normalized scattering intensity, and the horizontal axis means a scattering vector q.

### DESCRIPTION OF EMBODIMENTS

Hereinafter, embodiments of the present invention will be described in detail. In the following drawings, members and portions having the same functions may be denoted by the same reference numerals, and duplicate descriptions may be omitted or simplified. The embodiments described in the drawings are schematically for the purpose of clearly illustrating the present invention, and do not necessarily accurately represent a size or a scale of an actual product.

In the present description, the expression that a glass “is substantially free of” a certain component means that the component is not contained except for inevitable impurities, and means that the component is not positively added. Specifically, it means that the content of each of these components in the glass is about 100 ppm or less.

### [Borosilicate Glass]

A borosilicate glass according to an embodiment of the present invention contains:
in mol % in terms of oxide,
   70.0%≤SiO₂≤85.0%;
   5.0%≤B₂O₃≤20.0%;
   0.70%≤Al₂O₃≤10.0%;
   0.0%≤Li₂O≤5.0%;
   0.0%≤Na₂O≤10.0%;
   0.0%≤K₂O≤5.0%;
   0.0%≤MgO≤5.0%;
   0.0%≤CaO≤5.0%;
   0.0%≤SrO≤5.0%; and
   0.10%≤Fe₂O₃≤1.0%, in which
   the borosilicate glass has a total amount of SiO₂, Al₂O₃, and B₂O₃ of 85.0% or more,
   the borosilicate glass is substantially free of BaO, PbO, and As₂O₃, and
   T_{b}−Tₐ>0 is satisfied where T_{b} [%] is an average transmittance of a light having a wavelength of 900 nm to 1300 nm when the borosilicate glass is a flat glass and a thickness of the flat glass is converted to 1.50 mm, and Tₐ [%] is an average transmittance of the light having a wavelength of 900 nm to 1300 nm when the thickness is converted to 1.50 mm in a case where the flat glass is heated and bent at a temperature equal to or higher than a temperature T¹² at which a glass viscosity is 10¹² [dPa·s].

In addition, a borosilicate glass according to another embodiment of the present invention contains:
in mol % in terms of oxide,
   70.0%≤SiO₂≤85.0%;
   5.0%≤B₂O₃≤20.0%;
   0.70%≤Al₂O₃≤10.0%;
   0.0%≤Li₂O≤5.0%;
   0.0%≤Na₂O≤10.0%;
   0.0%≤K₂O≤5.0%;
   0.0%≤MgO≤5.0%;
   0.0%≤CaO≤5.0%;
   0.0%≤SrO≤5.0%; and
   0.10%≤Fe₂O₃≤1.0%, in which
   the borosilicate glass has a total amount of SiO₂, Al₂O₃, and B₂O₃ of 85.0% or more,
   the borosilicate glass is substantially free of BaO, PbO, and As₂O₃,
   a maximum value of a normalized scattering intensity in a range of a scattering vector q of 0.10 to 2.0 (nm⁻¹) by small-angle X-ray scattering (SAXS) measurement is 0.35 or more when the borosilicate glass is a flat glass, and
   the maximum value of the normalized scattering intensity in the range of the scattering vector q of 0.10 to 2.0 (nm⁻¹) by the SAXS measurement is reduced in a case where the flat glass is heated and bent at a temperature equal to or higher than a temperature T₁₂ at which a glass viscosity is 10¹² [dPa·s].

The borosilicate glass in the present embodiment is an oxide-based glass containing silicon dioxide as a main component and containing a boron component. The boron component in the borosilicate glass is a boron oxide (generic term for boron oxides such as diboron trioxide (B₂O₃)), and a proportion of the boron oxide in the glass is expressed in terms of B₂O₃.

Hereinafter, a composition range of each component contained in the borosilicate glass according to the present embodiment will be described. Note that, the composition range of each component will hereinafter be expressed in mol % in terms of oxide unless otherwise specified.

SiO₂ is an essential component in the borosilicate glass according to the present embodiment. A content of SiO₂ is 70.0% or more and 85.0% or less. SiO₂ contributes to improving a Young's modulus, thereby making it easier to ensure strength required for automobile applications, and the like. When the content of SiO₂ is small, it is difficult to ensure weather resistance, an average linear expansion coefficient is too large, a thermal stress may be generated due to a temperature distribution in a glass plate and thermal cracks of the glass plate may occur during bending and forming, and it may be difficult to control the shape of the glass after bending and forming. On the other hand, when the content of SiO₂ is too large, the viscosity during glass melting increases, which may make it difficult to produce the glass.

The content of SiO₂ in the borosilicate glass according to the present embodiment is preferably 72.0% or more, more preferably 74.0% or more, still more preferably 75.0% or more, and particularly preferably 76.0% or more. In addition, the content of SiO₂ in the borosilicate glass according to the present embodiment is preferably 84.0% or less, more preferably 83.5% or less, still more preferably 82.5% or less, even more preferably 82.0% or less, particularly preferably 81.0% or less, and most preferably 80.0% or less.

B₂O₃ is an essential component in the borosilicate glass according to the present embodiment. A content of B₂O₃ is 5.0% or more and 20.0% or less. B₂O₃ contributes to improving glass strength and meltability. In addition, B₂O₃ contributes to improving millimeter radio wave transmissibility of the glass. By improving the millimeter radio wave transmissibility, the glass can be suitably used for a glass for automobiles and the like equipped with millimeter wave radars. In addition to the millimeter wave radars, communication performance using millimeter waves inside and outside the vehicle can also be improved. Here, the “millimeter radio wave transmissibility” means an evaluation for radio wave (including quasi-millimeter wave and millimeter wave) transmissibility, and means, for example, radio wave transmissibility of a glass with respect to a radio wave having a frequency of 10 GHz to 90 GHz. When B₂O₃ is contained, as will be described later, absorption of iron ions in the glass can be controlled by utilizing a microstructural change in the glass caused by a heat treatment, and an excellent heat shielding property can be achieved for a window glass for a vehicle.

The content of B₂O₃ in the borosilicate glass according to the present embodiment is preferably 6.0% or more, more preferably 6.5% or more, still more preferably 7.0% or more, particularly preferably 7.5% or more, and most preferably 8.0% or more.

On the other hand, when the content of B₂O₃ is too large, an alkali element is likely to volatilize during melting and forming, which may lead to a decrease in glass quality and a decrease in acid resistance and alkali resistance. The content of B₂O₃ in the borosilicate glass according to the present embodiment is preferably 18.0% or less, more preferably 16.0% or less, still more preferably 14.0% or less, particularly preferably 13.0% or less, and most preferably 12.0% or less.

Al₂O₃ is an essential component in the borosilicate glass according to the present embodiment. A content of Al₂O₃ is 0.70% or more and 10.0% or less. When the content of Al₂O₃ is small, it is difficult to ensure the weather resistance, and the average linear expansion coefficient is too large, which may cause thermal cracks of the glass plate. On the other hand, when the content of Al₂O₃ is too large, the viscosity during glass melting or the viscosity during bending and forming (temperatures T₁₁ and T₁₂) increases, which may make it difficult to produce the glass.

In order to prevent phase separation of the glass and improve the weather resistance, the content of Al₂O₃ is preferably 1.0% or more, more preferably 1.5% or more, still more preferably 2.0% or more, particularly preferably 2.5% or more, and most preferably 3.0% or more. From the viewpoint of keeping the temperatures Ti and T₁₂ of the borosilicate glass low to make it easier to produce a bent glass, and from the viewpoint of increasing a millimeter radio wave transmittance, the content of Al₂O₃ is preferably 9.0% or less, more preferably 8.5% or less, still more preferably 8.0% or less, particularly preferably 7.5% or less, and most preferably 7.0% or less.

Note that, in the present description, T11 represents a temperature at which the glass viscosity is 10¹¹ [dPa·s], and T₁₂ represents a temperature at which the glass viscosity is 10¹² [dPa·s].

SiO₂+Al₂O₃+B₂O₃ in the borosilicate glass according to the present embodiment, that is, a total of the content of SiO₂, the content of Al₂O₃, and the content of B₂O₃ may be 85.0% or more and 98.0% or less. Within the above range, the millimeter radio wave transmittance is improved. In addition, in consideration of adjusting the temperatures T₁₁ and T₁₂ of the borosilicate glass according to the present embodiment to make it easier to produce a bent glass, SiO₂+Al₂O₃+B₂O₃ is preferably 97.0% or less, more preferably 96.0% or less, and still more preferably 95.0% or less. However, when SiO₂+Al₂O₃+B₂O₃ is too small, the weather resistance may decrease, and a relative dielectric constant (εᵣ) and a dielectric loss tangent (tan δ) may be too large. Therefore, SiO₂+Al₂O₃ +B₂O₃ in the borosilicate glass according to the present embodiment is preferably 88.0% or more, more preferably 89.0% or more, and still more preferably 90.0% or more.

Li₂O is an optional component in the borosilicate glass according to the present embodiment. A content of Li₂O is 0.0% or more and 5.0% or less. Li₂O is a component that improves the meltability of the glass, and a component that makes it easier to increase the Young's modulus and also contributes to improving the glass strength. When Li₂O is contained, the glass viscosity decreases, and thus formability of a window glass for a vehicle, particularly a windshield or the like, is improved. In the case where Li₂O is contained in the borosilicate glass according to the present embodiment, the content thereof may be 0.20% or more, is preferably 0.50% or more, more preferably 1.0% or more, still more preferably 1.5% or more, particularly preferably 2.0% or more, and most preferably 2.2% or more.

On the other hand, when the content of Li₂O is too large, devitrification may occur during the production of the glass, which may make the production difficult. In addition, a large content of Li₂O may cause an increase in raw material cost and an increase in relative dielectric constant (εᵣ) and dielectric loss tangent (tan δ). Therefore, the content of Li₂O is preferably 4.5% or less, more preferably 4.0% or less, still more preferably 3.5% or less, particularly preferably 3.0% or less, and most preferably 2.5% or less.

Na₂O is an optional component in the borosilicate glass according to the present embodiment. A content of Na₂O is 0.0% or more and 10.0% or less. Na₂O is a component that improves the meltability of the glass, and is preferably contained in an amount of 0.10% or more. When Na₂O is contained, the glass viscosity decreases, and thus formability of a window glass for a vehicle, particularly a windshield, is improved. In the case where Na₂O is contained, the content thereof is preferably 0.20% or more, more preferably 0.40% or more, still more preferably 0.50% or more, particularly preferably 1.0% or more, and most preferably 2.0% or more.

On the other hand, when the content of Na₂O is too large, the average linear expansion coefficient is too large, which may easily cause thermal cracks of the glass plate. In addition, it causes an increase in relative dielectric constant (εᵣ) and dielectric loss tangent (tan δ). Therefore, the content of Na₂O is preferably 9.0% or less, more preferably 8.0% or less, still more preferably 7.5% or less, particularly preferably 7.0% or less, and most preferably 6.5% or less.

K₂O is an optional component in the borosilicate glass according to the present embodiment. A content of K₂O is 0.0% or more and 5.0% or less. K₂O is a component that improves the meltability of the glass, and may be contained in an amount of 0.10% or more. The content of K₂O is preferably 0.30% or more, more preferably 0.60% or more, still more preferably 1.0% or more, even more preferably 1.5% or more, particularly preferably 2.0% or more, and most preferably 2.4% or more.

On the other hand, when the content of K₂O is too large, the average linear expansion coefficient is too large, which may easily cause thermal cracks of the glass plate. In addition, it causes an increase in relative dielectric constant (εᵣ) and dielectric loss tangent (tan δ). Therefore, the content of K₂O is preferably 4.5% or less, more preferably 4.0% or less, still more preferably 3.5% or less, and particularly preferably 3.0% or less.

A content of R₂O in the borosilicate glass according to the present embodiment may be 3.0% or more and 15% or less. From the viewpoint of improving the meltability of the glass and the formability (a decrease in T₁₁ and a decrease in T₁₂) of the bent glass, the content of R₂O is preferably 3.0% or more, more preferably 4.0% or more, still more preferably 5.0% or more, particularly preferably 6.0% or more, and most preferably 7.0% or more. When the content of R₂O is large, the average linear expansion coefficient is too large, a thermal stress may be generated due to a temperature distribution in the glass plate and thermal cracks of the glass plate may occur during bending and forming, and it may be difficult to control the shape of the glass after bending and forming. In addition, the millimeter radio wave transmittance may decrease. Therefore, the content of R₂O is preferably 15% or less, more preferably 13% or less, still more preferably 12% or less, particularly preferably 11% or less, and most preferably 10% or less. Here, R₂O represents a total amount of Li₂O, Na₂O, and K₂O.

MgO is an optional component in the borosilicate glass according to the present embodiment. A content of MgO is 0.0% or more and 5.0% or less. MgO is a component that promotes melting of a glass raw material and that improves the weather resistance and the Young's modulus. In the case where MgO is contained, the content thereof is preferably 0.10% or more, more preferably 0.50% or more, and still more preferably 1.0% or more. When the content of MgO is 5.0% or less, devitrification is difficult. In addition, an increase in relative dielectric constant (εᵣ) and dielectric loss tangent (tan δ) can be prevented. The content of MgO is preferably 4.0% or less, more preferably 3.0% or less, still more preferably 2.5% or less, particularly preferably 2.0% or less, and most preferably 1.5% or less.

CaO is an optional component in the borosilicate glass according to the present embodiment, and may be contained in a certain amount for improving the meltability of the glass raw material. A content of CaO is 0.0% or more and 5.0% or less. In the case where CaO is contained, the content thereof is preferably 0.10% or more, more preferably 0.50% or more, and still more preferably 1.0% or more. Accordingly, the meltability of the glass raw material and the formability (a decrease in T₁₁ and a decrease in T₁₂) of the bent glass are improved.

In addition, when the content of CaO is set to 5.0% or less, an increase in specific gravity of the glass is prevented, and low brittleness and the strength are maintained. In order to prevent degradation of brittleness of the glass and to prevent an increase in relative dielectric constant (εᵣ) and dielectric loss tangent (tan δ) of the glass, the content of CaO is preferably 4.0% or less, more preferably 3.0% or less, still more preferably 2.5% or less, particularly preferably 2.0% or less, and most preferably 1.5% or less.

SrO is an optional component in the borosilicate glass according to the present embodiment, and may be contained in a certain amount for improving the meltability of the glass raw material. A content of SrO is 0.0% or more and 5.0% or less. In the case where SrO is contained, the content thereof is preferably 0.10% or more, more preferably 0.20% or more, and still more preferably 0.30% or more. Accordingly, the meltability of the glass raw material and the formability (a decrease in T₁₁ and a decrease in T₁₂) of the bent glass are improved.

In addition, when the content of SrO is set to 5.0% or less, an increase in specific gravity of the glass is prevented, and low brittleness and the strength are maintained. In order to prevent degradation of brittleness of the glass and to prevent an increase in relative dielectric constant (εᵣ) and dielectric loss tangent (tan δ) of the glass, the content of SrO is preferably 4.0% or less. In addition, the content of SrO is more preferably 3.0% or less, still more preferably 2.0% or less, and particularly preferably 1.0% or less, and it is most preferable that the borosilicate glass be substantially free of SrO.

A content of RO in the borosilicate glass according to the present embodiment may be 0.0% or more and 5.0% or less. From the viewpoint of improving the meltability and the Young's modulus of the glass, the content of RO is preferably 0.10% or more, more preferably 0.25% or more, still more preferably 0.50% or more, particularly preferably 0.75% or more, and most preferably 1.0% or more. When the content of RO is large, the average linear expansion coefficient is too large, a thermal stress may be generated due to a temperature distribution in the glass plate and thermal cracks of the glass plate may occur during bending and forming, and it may be difficult to control the shape of the glass after bending and forming. In addition, the millimeter radio wave transmittance may decrease. Therefore, the content of RO is preferably 5.0% or less, more preferably 4.5% or less, still more preferably 4.0% or less, particularly preferably 3.5% or less, and most preferably 3.0% or less. Here, RO represents a total amount of MgO, CaO, and SrO.

Fe₂O₃ is an essential component in the borosilicate glass according to the present embodiment, and is contained for providing the heat shielding property. A content of Fe₂O₃ is 0.10% or more and 1.0% or less. The content of Fe₂O₃ here refers to a total amount of iron including FeO, which is an oxide of divalent iron, and Fe₂O₃, which is an oxide of trivalent iron.

When the content of Fe₂O₃ is less than 0.10%, the borosilicate glass may not be able to be used for applications requiring the heat shielding property, and it may be necessary to use an expensive raw material having a low iron content for production of the glass plate. Further, when the content of Fe₂O₃ is less than 0.10%, heat radiation may reach a bottom surface of a melting furnace more than necessary during glass melting, and a load may be applied to a melting kiln. The content of Fe₂O₃ in the borosilicate glass according to the present embodiment is preferably 0.15% or more, more preferably 0.17% or more, and still more preferably 0.19% or more.

On the other hand, when the content of Fe₂O₃ is more than 1.0%, heat transfer by radiation may be hindered and the raw material may be difficult to melt during the production. The content of Fe₂O₃ is preferably 0.80% or less, more preferably 0.50% or less, and still more preferably 0.40% or less.

In addition, iron ions contained in the above Fe₂O₃ preferably satisfy 0.18≤[Fe²⁺]/([Fe²⁺]+[Fe³⁺])≤0.80 on a mass basis. When the redox ([Fe²⁺]/([Fe²⁺]+[Fe³])) is too low, the heat shielding property of the glass plate deteriorates. On the other hand, when the redox is too high, the absorption of ultraviolet rays may decrease.

Here, “[Fe²]” and “[Fe³]” respectively mean contents of Fe²⁺ and Fe³⁺ contained in the borosilicate glass according to the present embodiment. In addition, “[Fe²⁺]/([Fe²⁺]+[Fe³⁺])” means a ratio of the content of Fe²⁺ to a total content of Fe²⁺ and Fe³⁺ in the borosilicate glass according to the present embodiment.

[Fe²⁺]/([Fe²⁺]+[Fe³]) is determined by the following method.

A crushed glass is decomposed with a mixed acid of hydrofluoric acid and hydrochloric acid at room temperature, then a certain amount of the decomposition solution is dispensed into a plastic container, and a hydroxylammonium chloride solution is added to reduce Fe³⁺ in the sample solution to Fe²⁺. Thereafter, a 2,2′-dipyridyl solution and an ammonium acetate buffer solution are added to develop the color of Fe². A color development solution is adjusted to a certain amount with ion exchanged water, and an absorbance at a wavelength of 522 nm is measured with an absorptiometer. Then, a concentration is calculated based on a calibration curve prepared by using the standard solution to determine the amount of Fe². Since Fe³⁺ in the sample solution is reduced to Fe₂₊, the amount of Fe²⁺ means “[Fe²⁺]+[Fe³]” in the sample.

Next, a crushed glass is decomposed with a mixed acid of hydrofluoric acid and hydrochloric acid at room temperature, then a certain amount of the decomposition solution is dispensed into a plastic container, and a 2,2′-dipyridyl solution and an ammonium acetate buffer solution are quickly added to develop the color of Fe₂₊ only. A color development solution is adjusted to a certain amount with ion exchanged water, and an absorbance at a wavelength of 522 nm is measured with an absorptiometer. Then, a concentration is calculated based on a calibration curve prepared by using the standard solution to calculate the amount of Fe²⁺. The amount of Fe²⁺ means [Fe²⁺] in the sample.

Then, [Fe²⁺]/([Fe²⁺]+[Fe³]) is calculated based on the determined [Fe²⁺] and [Fe²⁺]+[Fe³⁺].

The borosilicate glass according to the present embodiment is substantially free of BaO, PbO, and As₂O₃. By being substantially free of BaO, an increase in specific gravity of the glass is prevented, and low brittleness and the strength are maintained. In addition, the glass can be prevented from being brittle. In addition, being substantially free of PbO and As₂O₃ can prevent an influence on the human body and the environment.

The borosilicate glass according to the present embodiment satisfies the following expression (1), where T_{b} [%] is an average transmittance of a light having a wavelength of 900 nm to 1300 nm when the borosilicate glass is a flat glass and a thickness of the flat glass is converted to 1.50 mm, and Tₐ [%] is an average transmittance of a light having a wavelength of 900 nm to 1300 nm when the thickness is converted to 1.50 mm in the case where the flat glass is heated and bent at a temperature equal to or higher than the temperature T₁₂ at which the glass viscosity is 10¹² [dPa·s].

$${T}_{b} - {T}_{a} > 0 \qquad ( 1 )$$

The expression (1) means that in the case where the flat glass is heated and bent at a temperature equal to or higher than T₁₂, which is the bending and forming temperature of the glass, the average transmittance of a light having a wavelength of 900 nm to 1300 nm is reduced. When the flat glass is heated at a temperature equal to or higher than T₁₂, bending and forming of the glass is possible.

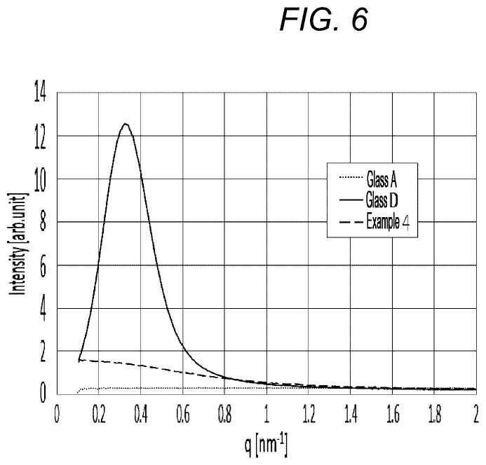

As shown in the embodiment or Examples to be described later, the borosilicate glass according to the present embodiment exhibits a scattering intensity by small-angle X-ray scattering (SAXS), and has a peak at a specific scattering vector q before the bending and forming. In the case where such a peak is observed, an interference effect called interparticle interference occurs due to a large proportion of heterogeneous phases. When the borosilicate glass according to the present embodiment is subjected to bending and forming, a reduction in scattering intensity and a change in peak are observed, as shown in a glass D in FIG. 6. This is due to the fact that the bending and forming causes a structural change in the glass, resulting in a reduction in heterogeneous structure. Light absorption of the borosilicate glass in the present embodiment is due to Fe ions, and the light absorption behavior is greatly influenced by the Fe structure in the glass structure. As a result of a microstructural change in the glass as described above, the light absorption behavior changes due to the structure around the Fe ions, resulting in a change in transmittance.

That is, when the borosilicate glass according to the present embodiment is bent, heat is applied to the glass, which causes a microstructural change in the glass and a change in absorption behavior of the Fe ions caused by Fe₂O₃. Accordingly, the average transmittance of the light in the above wavelength range is reduced.

In this way, with the borosilicate glass according to the present embodiment, since the transmittance in a near-infrared region decreases from near a boundary between a visible region and the near-infrared region by performing the bending, a bent glass having an improved heat shielding property can be obtained.

In addition, as bending and forming conditions for the glass, for example, the flat glass is heated to 630° C. and the bending time is 6 minutes. Note that, as for the bending and forming conditions, as described above, the flat glass may be subjected to, for example, a step of press forming for a predetermined period of time using a mold in a state in which the heating temperature is maintained at T₁₂ or higher to form a bent glass. As the bending and forming conditions at this time, the flat glass may be heated to a heating temperature of T₁₂ or higher and maintained in a bent state for 0.1 seconds or longer, for example, as a bending and forming time, and then the flat glass may be cooled. Note that, the temperature condition of making the heating temperature T₁₂ or higher may vary depending on the glass composition. For example, the temperature may be adjusted within the range of 600° C. to 700° C., but the temperature may be outside this temperature range as long as it is T₁₂ or higher. Further, the bending and forming time may be 1 second or longer, 5 seconds or longer, 10 seconds or longer, 30 seconds or longer, 1 minute or longer, 5 minutes or longer, or even 10 minutes or longer.

In the borosilicate glass according to the present embodiment, T_{b}−Tₐ is preferably 0.50% or more, more preferably 0.70% or more, and still more preferably 0.90% or more.

In a borosilicate glass according to another embodiment of the present invention, a maximum value of a normalized scattering intensity in a range of a scattering vector q of 0.10 to 2.0 (nm⁻¹) by small-angle X-ray scattering (SAXS) measurement is 0.35 or more when the borosilicate glass is a flat glass, and the maximum value of the normalized scattering intensity in the range of the scattering vector q of 0.10 to 2.0 (nm⁻¹) by the SAXS measurement is reduced in a case where the flat glass is heated and bent at a temperature equal to or higher than a temperature T₁₂ at which a glass viscosity is 10¹² [dPa·s].

The above SAXS measurement is performed under the conditions described in Examples to be described later.

In the borosilicate glass according to the present embodiment, the maximum value of the normalized scattering intensity in the range of the scattering vector q of 0.10 to 2.0 (nm⁻¹) is 0.35 or more, and the maximum value is reduced by the bending and forming. As described above, this is due to the fact that, in the borosilicate glass according to the present embodiment, the bending and forming causes a structural change in the glass, resulting in a reduction in heterogeneous structure. Light absorption of the borosilicate glass in the present embodiment is due to Fe ions, and the light absorption behavior is greatly influenced by the Fe structure in the glass structure. As a result of a microstructural change in the glass as described above, the light absorption behavior changes due to the structure around the Fe ions, resulting in a change in transmittance.

That is, when the borosilicate glass according to the present embodiment is bent, heat is applied to the glass, which causes a microstructural change in the glass and a change in absorption behavior of the Fe ions caused by Fe₂O₃. Therefore, it is possible to obtain a bent glass having a reduced average transmittance of the light in the above wavelength range, and therefore, having an improved heat shielding property.

In the borosilicate glass according to the present embodiment, the maximum value of the normalized scattering intensity in the range of the scattering vector q of 0.10 to 2.0 (nm⁻¹) by the SAXS measurement is reduced by the bending and forming. Here, as a ratio (Sₐ/S_{b}) of a maximum value (Sₐ) of a normalized scattering intensity after the bending and forming to a maximum value (S_{b}) of a normalized scattering intensity before the bending and forming, a rate of change in the above maximum value of the normalized scattering intensity before and after the bending and forming, that is, 1−(Sₐ/S_{b}) is preferably 0.05 or more, more preferably 0.10 or more, still more preferably 0.30 or more, particularly preferably 0.50 or more, and most preferably 0.80 or more.

The borosilicate glass according to the present embodiment preferably satisfies the following expression (2), where Tts1 is a total solar transmittance defined by ISO-13837:2008 convention A and measured at a wind speed of 4 m/s when the borosilicate glass is a flat glass and a thickness of the flat glass is converted to 1.50 mm, and Tts2 is a total solar transmittance defined by ISO-13837:2008 convention A and measured at a wind speed of 4 m/s when the thickness is converted to 1.50 mm in the case where the flat glass is heated and bent at a temperature equal to or higher than the temperature T₁₂ at which the glass viscosity is 10¹² [dPa·s].

$$( Tts 1 - Tts 2 ) / Tts 1 \geq 0.002 \qquad ( 2 )$$

The above expression (2) means that in the case where flat glass is bent at the above predetermined temperature, the rate of change in total solar transmittance is large before and after bending the glass. As described above, this means that the bending and forming causes a structural change in the glass, resulting in a reduction in heterogeneous structure, and thereby the total solar transmittance decreases. The borosilicate glass according to the present embodiment has a degree of change in total solar transmittance represented by the above expression (2) equal to or larger than a certain value, that is, the above change in coloring due to bending at a predetermined temperature is increased.

In this way, with the borosilicate glass according to the present embodiment, by performing the bending, the total solar transmittance can be reduced, and as a result, the heat shielding property can be improved.

In the borosilicate glass according to the present embodiment, (Tts1−Tts2)/Tts1 is preferably 0.004 or more, more preferably 0.008 or more, still more preferably 0.010 or more, and particularly preferably 0.015 or more.

In addition, the borosilicate glass according to the present embodiment may satisfy the following expression (3), where Tv1 is a visible light transmittance of a glass plate before bending when the borosilicate glass is a flat glass and a thickness of the flat glass is converted into 1.50 mm, and Tv2 is a visible light transmittance of the glass plate after being heated and bent at a temperature equal to or higher than the temperature T₁₂ at which the glass viscosity is 10^{12 [}dPa·s].

$$Tv 1 - Tv 2 < 0 \qquad ( 3 )$$

Here, the above visible light transmittance is measured according to the method specified in ISO-9050:2003 using a D65 light source.

The above expression (3) means that in the case where the flat glass is bent at the above predetermined temperature, the rate of change in visible light transmittance is increased before and after bending the glass. As described above, this means that the bending and forming causes a structural change in the glass, resulting in a reduction in heterogeneous structure, and thereby scattering in the visible light region is prevented and the visible light transmittance is improved.

In this way, with the borosilicate glass according to the present embodiment, by performing the bending, the visible light transmittance can be improved, and as a result, visibility can be improved.

In the borosilicate glass according to the present embodiment, when moisture is present in the glass, a light in the near-infrared region is absorbed. Therefore, the borosilicate glass according to the present embodiment preferably contains a certain amount of moisture in order to improve the heat shielding property. The moisture in the glass can be generally expressed by a value called a β-OH value, and the β-OH value is preferably 0.050 mm⁻¹ or more, more preferably 0.10 mm⁻¹ or more, and still more preferably 0.15 mm⁻¹ or more. The β-OH is obtained by the following expression based on a transmittance of the glass measured using a FT-IR (Fourier transform infrared spectrophotometer).

$$β - OH = ( 1 / X ) {log}_{10} ( {T}_{A} / {T}_{B} ) [ {mm}^{- 1} ]$$

X: sample thickness [mm]
T_{A}: transmittance [%] at a reference wave number of 4000 cm⁻¹
T_{B}: minimum transmittance [%] near a hydroxy group absorption wave number of 3600 cm⁻¹

On the other hand, when the amount of moisture in the glass is too large, inconvenience may occur in transmission and reception of a millimeter radio wave and in using an infrared irradiation device (laser radar or the like). Therefore, the β-OH value of the borosilicate glass according to the present embodiment is preferably 0.70 mm⁻¹ or less, more preferably 0.60 mm⁻¹ or less, still more preferably 0.50 mm⁻¹ or less, and particularly preferably 0.40 mm⁻¹ or less.

In the borosilicate glass according present embodiment, [Al₂O₃]/([SiO₂]+[B₂O₃]) is preferably 0.050 or less, more preferably 0.045 or less, and still more preferably 0.040 or less. Accordingly, a low dielectric constant can be maintained. Here, [Al₂O₃], [SiO₂], and [B₂O₃] respectively mean the contents of Al₂O₃, SiO₂, and B₂O₃ contained in the borosilicate glass according to the present embodiment. In addition, “[Al₂O₃]/([SiO₂]+[B₂O₃])” means a proportion of the content of Al₂O₃ to a total content of SiO₂ and B₂O₃ in the borosilicate glass according to the present embodiment.

In the borosilicate glass according to the present embodiment, [Al₂O₃]/([SiO₂]+[B₂O₃]) is preferably 0.005 or more, more preferably 0.008 or more, and still more preferably 0.010 or more.

The borosilicate glass according to the present embodiment may have a density of 2.0 g/cm³ or more and 2.5 g/cm³ or less. In addition, the borosilicate glass according to the present embodiment may have a Young's modulus of 50 GPa or more and 80 GPa or less.

The borosilicate glass according to the present embodiment preferably contains a certain amount or more of SiO₂ in order to ensure the weather resistance, and as a result, the density of the borosilicate glass according to the present embodiment may be 2.0 g/cm³ or more. The density of the borosilicate glass according to the present embodiment is preferably 2.1 g/cm³ or more. In addition, when the density according to the borosilicate glass according to the present embodiment is 2.5 g/cm³ or less, the borosilicate glass is less likely to be brittle, and weight reduction is achieved. The density of the borosilicate glass according to the present embodiment is preferably 2.4 g/cm³ or less.

The borosilicate glass according to the present embodiment has high rigidity when the Young's modulus increases, and is more suitable for a window glass for a vehicle or the like. The Young's modulus of the borosilicate glass according to the present embodiment is preferably 55 GPa or more, more preferably 60 GPa or more, and still more preferably 62 GPa or more. On the other hand, when the content of Al₂O₃ or MgO is increased in order to increase the Young's modulus, the relative dielectric constant (εᵣ) and the dielectric loss tangent (tan δ) of the glass increase, and therefore, an appropriate Young's modulus of the borosilicate glass according to the present embodiment is 78 GPa or less, more preferably 76 GPa or less, and still more preferably 74 GPa or less.

In the borosilicate glass according to the present embodiment, it is preferable to reduce the average linear expansion coefficient, since generation of a thermal stress due to a temperature distribution in the glass plate is prevented, and thermal cracks of the glass plate is less likely to occur. In the borosilicate glass according to the present embodiment, an average linear expansion coefficient from 50° C. to 350° C. is preferably 25×10⁻⁷/K or more, more preferably 28×10⁻⁷/K or more, still more preferably 30×10⁻⁷/K or more, particularly preferably 32×10⁻⁷/K or more, and most preferably 35×10⁻⁷/K or more.

On the other hand, in the borosilicate glass according to the present embodiment, when the average linear expansion coefficient is too large, a thermal stress may be likely to generate due to a temperature distribution in the glass plate, and thermal cracks of the glass plate may occur in a forming step and a slow cooling step of the glass plate, or a forming step of a windshield, a roof glass, and a rear glass. In addition, in the borosilicate glass according to the present embodiment, when the average linear expansion coefficient is too large, a difference in expansion between the glass plate and a support member or the like is increased, which causes distortion, and the glass plate may crack.

In the borosilicate glass according to the present embodiment, the average linear expansion coefficient from 50° C. to 350° C. may be 60×10⁻⁷/K or less, is preferably 58×10⁻⁷/K or less, more preferably 56×10⁻⁷/K or less, still more preferably 54×10⁻⁷/K or less, particularly preferably 52×10⁻⁷/K or less, and most preferably 50×10⁻⁷/K or less.

In the borosilicate glass according to the present embodiment, T₁₂ is preferably 650° C. or lower, more preferably 640° C. or lower, still more preferably 630° C. or lower, particularly preferably 620° C. or lower, and most preferably 610° C. or lower.

In the borosilicate glass according to the present embodiment, T₁₁ is preferably 680° C. or lower, more preferably 670° C. or lower, still more preferably 660° C. or lower, particularly preferably 650° C. or lower, and most preferably 640° C. or lower.

When T₁₁ and T₁₂ are within the above ranges, the energy required during a bending heat treatment is kept low, and the bending heat treatment can be performed under the same conditions as a soda lime glass used in a general automobile glass, leading to a shorter takt time.

In addition, in the borosilicate glass according to the present embodiment, T_{g} is preferably 400° C. or higher and 650° C. or lower. Note that, in the present description, T_{g} represents a glass transition point of the glass. When T_{g} is within this predetermined temperature range, the glass can be bent within general production condition ranges. When T_{g} of the borosilicate glass according to the present embodiment is lower than 400° C., there is no problem in formability, but an alkali content or an alkaline earth content is too large, and problems that the average linear expansion coefficient of the glass is excessively large, the weather resistance decreases, or the like are likely to occur. In addition, when T_{g} of the borosilicate glass according to the present embodiment is lower than 400° C., the glass may devitrify and cannot be formed in a forming temperature range.

T_{g} of the borosilicate glass according to the present embodiment is more preferably 450° C. or higher, still more preferably 470° C. or higher, and particularly preferably 490° C. or higher. On the other hand, when T_{g} is too high, a high temperature is required during glass bending, which makes the production difficult.

In the borosilicate glass according to the present embodiment, T_{g} is more preferably 600° C. or lower, still more preferably 580° C. or lower, particularly preferably 550° C. or lower, and most preferably 530° C. or lower.

The borosilicate glass according to the present embodiment may contain components other than the above-described SiO₂, B₂O₃, Al₂O₃, Li₂O, Na₂O, K₂O, MgO, CaO, SrO, and Fe₂O₃ (hereinafter, also referred to as “other components”). Examples of the other components include ZrO₂, Y₂O₃, TiO₂, CeO₂, ZnO, Nd₂O₅, P₂O₅, GaO₂, GeO₂, MnO₂, CoO, Cr₂O₃, V₂O₅, Se, Au₂O₃, Ag₂O, CuO, CdO, SO₃, Cl, F, SnO₂, and Sb₂O₃, and the other components may be metal ions or oxides. In the case where these components are contained, a total content thereof is preferably 5.0% or less, more preferably 3.0% or less, and particularly preferably 2.0% or less.

The borosilicate glass according to the present embodiment is preferably substantially free of Er₂O₃. Accordingly, absorption of visible light, particularly light in a blue region to light in a green region (wavelength of 400 nm to 550 nm) can be prevented. In this case, a transmittance of a light having a wavelength of 500 nm can be 78.0% or more when a thickness of the borosilicate glass according to the present embodiment is converted into 1.50 mm.

The borosilicate glass according to the present embodiment may contain Cr₂O₃. Cr₂O₃ can act as an oxidant to control an amount of FeO. In the case where the borosilicate glass according to the present embodiment contains Cr₂O₃, a content thereof is preferably 0.0020% or more, and more preferably 0.0040% or more. Since Cr₂O₃ has a coloring property in a light in a visible region, the visible light transmittance may decrease. In the case where the borosilicate glass according to the present embodiment contains Cr₂O₃, the content thereof is preferably 1.0% or less, more preferably 0.50% or less, still more preferably 0.30% or less, and particularly preferably 0.10% or less.

The borosilicate glass according to the present embodiment may contain SnO₂. SnO₂ can act as a reducing agent to control the amount of FeO. In the case where the borosilicate glass according to the present embodiment contains SnO₂, a content thereof is preferably 0.010% or more, more preferably 0.040% or more, still more preferably 0.060% or more, and particularly preferably 0.080% or more. On the other hand, in order to prevent defects derived from SnO₂ during the production of the glass plate, the content of SnO₂ in the borosilicate glass according to the present embodiment is preferably 1.0% or less, more preferably 0.50% or less, still more preferably 0.30% or less, and particularly preferably 0.20% or less.

The borosilicate glass according to the present embodiment may contain P₂O₅. P₂O₅ improves the meltability, but tends to cause defects in the glass in a float bath in production of the borosilicate glass according to the present embodiment with a float method. Therefore, a content of P₂O₅ in the borosilicate glass according to the present embodiment is preferably 5.0% or less, more preferably 1.0% or less, still more preferably 0.10% or less, particularly preferably 0.050% or less, and most preferably less than 0.010%.

ZrO₂ may be contained in order to improve chemical durability, and in the case where ZrO₂ is contained, a content thereof is preferably 0.5% or more. Since the average linear expansion coefficient may be increased, the content of ZrO₂ is more preferably 1.8% or less, and still more preferably 1.5% or less.

The borosilicate glass according to the present embodiment preferably has a sufficient visible light transmittance. The visible light transmittance of the borosilicate glass according to the present embodiment is a value calculated based on a calculation equation defined in JIS R3106 (2019) using a spectrophotometer or the like.

In the case where the borosilicate glass according to the present embodiment is used as a windshield, a transmittance of a light having a wavelength of 500 nm is preferably 78.0% or more, more preferably 80.0% or more, and still more preferably 82.0% or more when the thickness of the borosilicate glass is converted into 1.50 mm. The transmittance of the light having the above wavelength is, for example, 90.0% or less.

In the case where the borosilicate glass according to the present embodiment is used as a windshield, an average transmittance of a light having a wavelength of 450 nm to 700 nm is preferably 78.0% or more, more preferably 80.0% or more, and still more preferably 82.0% or more when the thickness of the borosilicate glass is converted into 1.50 mm. The average transmittance of the light having the above wavelength is, for example, 90.0% or less. The average transmittance here means an average value of transmittances measured at an interval of 1 nm.

In the borosilicate glass according to the present embodiment, a transmittance of a light having a wavelength of 1000 nm is preferably 90.0% or less, more preferably 85.0% or less, and still more preferably 80.0% or less when the thickness of the borosilicate glass is converted into 1.50 mm. The transmittance of the light having the above wavelength is, for example, 50.0% or more.

In the borosilicate glass according to the present embodiment, an average transmittance of a light having a wavelength of 900 nm to 1300 nm is preferably 90.0% or less, more preferably 85.0% or less, and still more preferably 80.0% or less when the thickness of the borosilicate glass is converted into 1.50 mm. The average transmittance of the light having the above wavelength is, for example, 50.0% or more. The average transmittance here means an average value of transmittances measured at an interval of 1 nm.

From the viewpoint of impact resistance, the borosilicate glass according to the present embodiment has a thickness of preferably 1.50 mm or more, more preferably 1.80 mm or more, still more preferably 2.00 mm or more, particularly more preferably 2.20 mm or more, and most preferably 2.50 mm or more.

In addition, from the viewpoint of preventing an increase in weight, the thickness is preferably 4.50 mm or less, more preferably 4.00 mm or less, still more preferably 3.80 mm or less, and particularly preferably 3.70 mm or less.

The borosilicate glass according to the present embodiment preferably has a high millimeter radio wave transmittance. In the borosilicate glass according to the present embodiment, a low tan δ can be obtained by adjusting the composition, and as a result, a dielectric loss can be reduced, and a high millimeter radio wave transmittance can be achieved. In the borosilicate glass according to the present embodiment, the relative dielectric constant (εᵣ) can also be adjusted by adjusting the composition in the same manner, reflection of radio waves at an interface with the interlayer can be prevented, and a high millimeter radio wave transmittance can be achieved.

The relative dielectric constant (εᵣ) of the borosilicate glass according to the present embodiment at a frequency of 10 GHz is preferably 6.0 or less. When the relative dielectric constant (εᵣ) at a frequency of 10 GHz is 6.0 or less, a difference in relative dielectric constant (εᵣ) from the interlayer is small, and the reflection of radio waves at the interface with the interlayer can be prevented. The relative dielectric constant (εᵣ) of the borosilicate glass according to the present embodiment at a frequency of 10 GHz is more preferably 5.5 or less, still more preferably 5.3 or less, and particularly preferably 5.0 or less. In addition, a lower limit of the relative dielectric constant (εᵣ) of the borosilicate glass according to the present embodiment at a frequency of 10 GHz is not particularly limited, and is, for example, 3.8 or more.

The dielectric loss tangent (tan δ) of the borosilicate glass according to the present embodiment at a frequency of 10 GHz is preferably 0.010 or less. When the dielectric loss tangent (tan δ) at a frequency of 10 GHz is 0.010 or less, the radio wave transmittance can be increased. The dielectric loss tangent (tan δ) of the borosilicate glass according to the present embodiment at a frequency of 10 GHz is more preferably 0.009 or less, still more preferably 0.0085 or less, even more preferably 0.008 or less, particularly preferably 0.0075 or less, and most preferably 0.007 or less. In addition, a lower limit of the dielectric loss tangent (tan δ) of the borosilicate glass according to the present embodiment at a frequency of 10 GHz is not particularly limited, and is, for example, 0.003 or more.

When the relative dielectric constant (εᵣ) and the dielectric loss tangent (tan δ) of the borosilicate glass according to the present embodiment at a frequency of 10 GHz satisfy the above ranges, a high millimeter radio wave transmittance can be achieved even at a frequency of 10 GHz to 90 GHZ.

The relative dielectric constant (εᵣ) and the dielectric loss tangent (tan δ) of the borosilicate glass according to the present embodiment at a frequency of 10 GHz can be measured with, for example, a split post dielectric resonator method (SPDR method). For such measurement, a nominal fundamental frequency 10 GHz type split post dielectric resonator manufactured by QWED Company, a vector network analyzer E8361C manufactured by Keysight Technologies, 85071E option 300 dielectric constant calculation software manufactured by Keysight Technologies, or the like can be used.

A method for producing the borosilicate glass according to the present embodiment is not particularly limited, and for example, a float glass formed by a known float method or a fusion draw glass formed by a fusion draw method is preferred.

In the float method, a molten glass base material is floated on a molten metal such as tin, and a glass plate having a uniform thickness and width is formed under strict temperature control.

In the fusion draw method, a molten glass is continuously poured down from a formed body to form a glass ribbon in a band plate shape, and a glass plate having a uniform thickness and width is formed.

In the method for producing the borosilicate glass according to the present embodiment, an average cooling rate is preferably 1° C./min or more. The average cooling rate in the method for producing a borosilicate glass here is an average cooling rate when slowly cooling a formed glass. When the above average cooling rate is 1° C./min or more, a heterogeneous phase is generated during cooling, and the heat shielding property can be improved during preparation of the bent glass, which will be described later.

The above average cooling rate can be calculated as follows. The composition of the borosilicate glass whose average cooling rate is to be calculated is analyzed, and a plurality of glasses having the same composition are prepared at different average cooling rates. Refractive indexes of the prepared plurality of glasses are measured, and a calibration curve regarding the average cooling rate and the refractive index is created. By determining the refractive index of the glass whose average cooling rate is to be calculated, the average cooling rate can be calculated from the above calibration curve. The refractive index can be measured, for example, by a V block method.

The above average cooling rate is more preferably 5° C./min or more, still more preferably 10° C./min or more, even more preferably 20° C./min or more, particularly preferably 30° C./min or more, particularly preferably 35° C./min or more, and most preferably 40° C./min or more.

An upper limit of the above average cooling rate is not particularly limited, and is preferably 400° C./min or less, more preferably 350° C./min or less, still more preferably 300° C./min or less, particularly preferably 250° C./min or less, and most preferably 200° C./min or less. When the average cooling rate is 400° C./min or less, it is easy to form a thick glass.

### [Bent Glass]

A bent glass according to an embodiment of the present invention includes the above borosilicate glass. That is, it is formed by bending the above borosilicate glass. The bent glass according to the present embodiment may be a bent glass obtained by forming a flat plate-shaped borosilicate glass into a curved shape by gravity forming, press forming, or the like.

The bent glass according to the present embodiment is a glass that curves with a predetermined curvature, may be a single bent glass that curves only in one direction, either an up-and-down direction or a right-and-left direction, or may be a multi-bent glass that curves both in the up-and-down direction and the right-and-left direction.

The bent glass according to the present embodiment preferably has a minimum radius of curvature of 500 mm or more and 100,000 mm or less. Regarding the radius of curvature of the bent glass, the shape of the sample is calculated by a shape simulation using a laser displacement meter (Dyvoce manufactured by Kohzu Precision Co., Ltd.) based on an amount of warpage inherent in the sample, which is determined by self-weight deflection correction in a double-sided difference mode, and the radius of curvature is determined based on the shape obtained by the simulation.

### [Method for Producing Bent Glass]

In a method for producing a bent glass according to an embodiment of the present invention, a bent glass is formed by heating and bending the above borosilicate glass.

Examples of a forming method for the bent glass include a method of bending and forming a heated glass plate in a state of being placed in a mold and pressing it from above using a press.

Other examples include a method of placing a flat plate-shaped glass plate on a mold having a bending and forming surface corresponding to a desired curved surface, carrying the mold into a heating furnace in this state, and heating the glass plate in the heating furnace to a temperature near the softening point of the glass. According to this forming method, since the glass plate curves along the bending and forming surface of the mold due to the own weight along with softening, a glass plate having a desired curved surface is produced.

In the present embodiment, from the viewpoint of improving productivity and improving surface precision after forming, the above bending and forming using a press is preferred. The above bending and forming method using a press is not particularly limited, and for example, the method described in WO 2016/093031 can be used as appropriate. Hereinafter, the above bending and forming method using a press will be exemplified.

First, the borosilicate glass according to the present embodiment is transported to a press area using a transport conveyor or the like. Next, in the press area, the borosilicate glass is softened by heating it to a temperature at which it can be bent and formed. Here, the temperature at which the borosilicate glass can be bent and formed is, for example, equal to or higher than the temperature T₁₂ at which the glass viscosity is 10¹² [dPa·s]. Note that, the heating may be performed using a heater or the like in the heating furnace in the process of transporting the borosilicate glass to the press area using the transport conveyor or the like.

In addition, a bending and forming time under the condition that the heating temperature (≥T₁₂) is maintained can be set to, for example, 1 second or longer.

A lower press form (female form) and an upper press form (male form) are disposed at predetermined positions in the press area, and an upper surface shape of the female form and a lower surface shape of the male form correspond to the curved shape of the borosilicate glass to be subjected to bending and forming in a conveying direction and an orthogonal direction. The female form can be moved up and down between a standby position below the transport conveyor and a press position above the transport conveyor, and after the glass plate is transferred from the transport conveyor, is moved up from a predetermined raised position to the press position above the transport conveyor with the glass plate placed thereon, whereby the borosilicate glass is subjected to press forming.

Next, the press-formed borosilicate glass is transported to a cooling area using a transport shuttle or the like. In the cooling area, the borosilicate glass is cooled by blowing cooling air onto the borosilicate glass.

In the method for producing the bent glass according to the present embodiment, the average cooling rate is preferably 400° C./min or more. When the above average cooling rate is 400° C./min or more, it is possible to prevent the generation of heterogeneous structures during cooling and to reduce the average transmittance of a light having a wavelength of 900 nm to 1300 nm. The average cooling rate in the method for producing a bent glass here is an average cooling rate when slowly cooling the press-formed borosilicate glass.

The above average cooling rate is more preferably 450° C./min or more, still more preferably 500° C./min or more, and particularly preferably 600° C./min or more. An upper limit of the above average cooling rate is not particularly limited, and is preferably 3000° C./min or less, more preferably 2500° C./min or less, still more preferably 2000° C./min or less, particularly preferably 1800° C./min or less, and most preferably 1600° C./min or less, from the viewpoint of cooling equipment performance.

With the above steps, a bent glass is formed. Note that, although the bending and forming of the borosilicate glass according to the present embodiment has been described above, the bending and forming may also be performed in the state of a laminated glass, which will be described later.

### [Laminated Glass]

A laminated glass according to an embodiment of the present invention includes: a first glass plate; a second glass plate; and an interlayer sandwiched between the first glass plate and the second glass plate, in which at least one of the first glass plate and the second glass plate is the above borosilicate glass or the above bent glass.

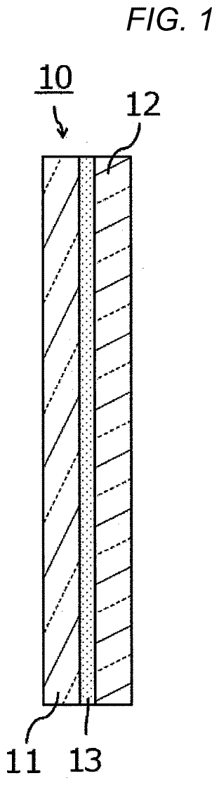

FIG. 1 is a view illustrating an example of a laminated glass 10 according to the present embodiment. The laminated glass 10 includes a first glass plate 11, a second glass plate 12, and an interlayer 13 sandwiched between the first glass plate 11 and the second glass plate 12. Note that, the laminated glass 10 according to the present embodiment is not limited to an aspect in FIG. 1, and can be modified without departing from the gist of the present invention. For example, the interlayer 13 may be formed as one layer as illustrated in FIG. 1, or may be formed as two or more layers. In addition, the laminated glass 10 according to the present embodiment may include three or more glass plates, and in this case, an organic resin or the like may be interposed between adjacent glass plates. Hereinafter, the laminated glass 10 according to the present embodiment will be described as a configuration in which only two glass plates, that is, the first glass plate 11 and the second glass plate 12 are included, and the interlayer 13 is sandwiched therebetween.

In the laminated glass according to the present embodiment, it is preferable to use the above borosilicate glass or the above bent glass for both the first glass plate 11 and the second glass plate 12 from the viewpoint of improving the heat shielding property. In this case, the first glass plate 11 and the second glass plate 12 may be borosilicate glasses or bent glasses having the same composition or may borosilicate glasses or bent glasses having different compositions.

In the case where one of the first glass plate 11 and the second glass plate 12 is not the above borosilicate glass or bent glass, the type of the glass plate is not particularly limited, and a known glass plate in the related art used for a window glass for a vehicle or the like can be used. Specific examples thereof include an alkali aluminosilicate glass and a soda lime glass. These glass plates may be colored to such an extent that transparency thereof is not impaired, or may not be colored.

In the laminated glass according to the present embodiment, one of the first glass plate 11 and the second glass plate 12 may be an alkali aluminosilicate glass containing 1.0% or more of Al₂O₃. By using the above alkali aluminosilicate glass as the first glass plate 11 or the second glass plate 12, chemical strengthening to be described later can be performed, and the strength can be increased. The alkali aluminosilicate glass also has an advantage of being easily chemically strengthened as compared with the borosilicate glass.

From the viewpoint of the weather resistance and the chemical strengthening, a content of Al₂O₃ in the above alkali aluminosilicate glass is more preferably 2.0% or more, and still more preferably 2.5% or more. In addition, in the alkali aluminosilicate glass, when the content of Al₂O₃ is large, the millimeter radio wave transmittance may decrease, and thus the content of Al₂O₃ is preferably 20% or less, and more preferably 15% or less.

From the viewpoint of the chemical strengthening, a content of R₂O in the above alkali aluminosilicate glass is preferably 10% or more, more preferably 12% or more, and still more preferably 13% or more. In addition, in the alkali aluminosilicate glass, when the content of R₂O is large, the millimeter radio wave transmittance may decrease, and thus the content of R₂O is preferably 25% or less, more preferably 20% or less, and still more preferably 19% or less. Here, R₂O represents a total amount of Li₂O, Na₂O, and K₂O.

Specific examples of the above alkali aluminosilicate glass include a glass having the following composition.
61%≤SiO₂≤77%
1.0%≤Al₂O₃≤20%
0.0%≤B₂O₃≤10%
0.0%≤MgO≤15%
0.0%≤CaO≤10%
0.0%≤SrO≤1.0%
0.0%≤BaO≤1.0%
0.0%≤Li₂O≤15%
2.0%≤Na₂O≤15%
0.0%≤K₂O≤6.0%
0.0%≤ZrO₂≤4.0%
0.0%≤TiO₂≤1.0%
0.0%≤Y₂O₃≤2.0%
10%≤R₂O≤25%
0.0%≤RO≤20%
(R₂O represents a total amount of Li₂O, Na₂O, and K₂O, and RO represents a total amount of MgO, CaO, SrO, and BaO.)

The soda lime glass may be a soda lime glass containing less than 1.0% of Al₂O₃. Specific examples thereof include a glass having the following composition.
60%≤SiO₂≤75%
0.0%≤Al₂O₃<1.0%
2.0%≤MgO≤11%
2.0%≤CaO≤10%
0.0%≤SrO≤3.0%
0.0%≤BaO≤3.0%
10% <Na₂O≤18%
0.0%≤K₂O≤8.0%
0.0%≤ZrO₂≤4.0%
0.0010%≤Fe₂O₃≤5.0%

A lower limit of a thickness of the first glass plate 11 or the second glass plate 12 is preferably 0.50 mm or more, more preferably 0.70 mm or more, still more preferably 1.00 mm or more, and particularly preferably 1.50 mm or more. When the thickness of the first glass plate 11 or the second glass plate 12 is 0.50 mm or more, a sound insulating property and the strength can be improved.

The first glass plate 11 and the second glass plate 12 may have the same thickness or may have different thicknesses.

Note that, in the laminated glass 10 according to the present embodiment, the thicknesses of the first glass plate 11 and the second glass plate 12 may be constant over the entire surface, or may be changed for each portion as necessary, such as forming a wedge shape in which the thickness of one or both of the first glass plate 11 and the second glass plate 12 is changed.

One or both of the first glass plate 11 and the second glass plate 12 may be subjected to a strengthening treatment in order to improve the strength. A strengthening method may be physical strengthening or chemical strengthening.

Examples of a method of the physical strengthening treatment include subjecting a glass plate to a heat strengthening treatment. In the heat strengthening treatment, a uniformly heated glass plate is rapidly cooled from a temperature near the softening point, and a compressive stress is generated on the surface of the glass due to a temperature difference between the surface of the glass and an inside of the glass. The compressive stress is generated uniformly over the entire surface of the glass, and a compressive stress layer having a uniform depth is formed over the entire surface of the glass. The heat strengthening treatment is more suitable for strengthening a thick glass plate than a chemical strengthening treatment.

Examples of a method of the chemical strengthening treatment include an ion exchange method. In the ion exchange method, a glass plate is immersed in a treatment solution (for example, potassium nitrate molten salt), and ions having a small ion radius (for example, Na ions) contained in the glass are exchanged for ions having a large ion radius (for example, K ions), thereby generating a compressive stress on the surface of the glass. The compressive stress is generated uniformly over the entire surface of the glass plate, and a compressive stress layer having a uniform depth is formed over the entire surface of the glass plate.

Each of a magnitude of the compressive stress on the surface of the glass plate (hereinafter, also referred to as a surface compressive stress CS) and a depth DOL of the compressive stress layer formed on the surface of the glass plate can be adjusted based on a glass composition, a chemical strengthening treatment time, and a chemical strengthening treatment temperature. Examples of a chemically strengthened glass include a glass obtained by performing the chemical strengthening treatment on the above alkali aluminosilicate glass.

The interlayer 13 according to the present embodiment is sandwiched between the first glass plate 11 and the second glass plate 12. Since the laminated glass 10 according to the present embodiment includes the interlayer 13, the first glass plate 11 and the second glass plate 12 firmly adhere to each other, and an impact force when scattered pieces collide with the glass plate can be reduced.

As the interlayer 13, various organic resins generally used for a laminated glass used as a vehicular laminated glass in the related art may be used. For example, a polyethylene (PE), an ethylene vinyl acetate copolymer (EVA), a polypropylene (PP), a polystyrene (PS), a methacrylic resin (PMA), polyvinyl chloride (PVC), polyethylene terephthalate (PET), polybutylene terephthalate (PBT), cellulose acetate (CA), a diallyl phthalate resin (DAP), a urea resin (UP), a melamine resin (MF), an unsaturated polyester (UP), polyvinyl butyral (PVB), polyvinyl formal (PVF), polyvinyl alcohol (PVAL), a vinyl acetate resin (PVAc), an ionomer (IO), polymethylpentene (TPX), vinylidene chloride (PVDC), polysulfone (PSF), polyvinylidene difluoride (PVDF), a methacrylate-styrene copolymer resin (MS), a polyarylate (PAR), polyarylsulfone (PASF), a polybutadiene (BR), polyethersulfone (PESF), or polyether ether ketone (PEEK) can be used. Among these, EVA and PVB are suitable from the viewpoint of transparency and adhesion, and PVB is particularly preferred because PVB can provide the sound insulating property.

A thickness of the interlayer 13 is preferably 0.30 mm or more, more preferably 0.50 mm or more, and still more preferably 0.70 mm or more, from the viewpoint of a reduction in impact force and the sound insulating property. In addition, the thickness of the interlayer 13 is preferably 1.00 mm or less, more preferably 0.90 mm or less, and still more preferably 0.80 mm or less, from the viewpoint of preventing a decrease in visible light transmittance. In addition, the thickness of the interlayer 13 is preferably in a range of 0.30 mm to 1.00 mm, and more preferably in a range of 0.70 mm to 0.80 mm.

The thickness of the interlayer 13 may be constant over the entire surface, or may be changed for each portion as necessary.

Note that, when a difference in linear expansion coefficient between the interlayer 13 and the first glass plate 11 or the second glass plate 12 is large, in the case where the laminated glass 10 is prepared through a heating step to be described later, the laminated glass 10 may be cracked or warped, resulting in a poor appearance. Therefore, the difference in linear expansion coefficient between the interlayer 13 and the first glass plate 11 or the second glass plate 12 is preferably as small as possible. The difference in linear expansion coefficient between the interlayer 13 and the first glass plate 11 or the second glass plate 12 may be represented by a difference between average linear expansion coefficients in a predetermined temperature range. Particularly, a resin constituting the interlayer 13 has a low glass transition point, and thus a predetermined average linear expansion coefficient difference may be set in a temperature range equal to or lower than the glass transition point of the resin material. Note that, a difference in linear expansion coefficient between the resin material and the first glass plate 11 or the second glass plate 12 may be set at a predetermined temperature equal to or lower than the glass transition point of the resin material.

As the interlayer 13, an adhesive layer containing an adhesive may be used, and the adhesive is not particularly limited, and for example, an acrylic adhesive or a silicone adhesive can be used.

In the case where the interlayer 13 is an adhesive layer, it is not necessary to perform the heating step in the process of bonding the first glass plate 11 and the second glass plate 12, and thus the above cracks or warpage is less likely to occur.

### [Other Layers]

The laminated glass 10 according to the embodiment of the present invention may include layers other than the first glass plate 11, the second glass plate 12, and the interlayer 13 (hereinafter, also referred to as “other layers”) within a range that does not impair effects of the present invention. For example, a coating layer that provides a water repellent function, a hydrophilic function, an anti-fogging function, or the like, or an infrared reflection film may be provided. Positions where the other layers are provided are not particularly limited, and the other layers may be provided on a surface of the laminated glass 10, or may be sandwiched between the first glass plate 11, the second glass plate 12, or the interlayer 13. In addition, the laminated glass 10 according to the present embodiment may include a black ceramic layer or the like which is disposed in a band shape on a part or all of a peripheral edge portion for the purpose of hiding an attachment portion to a frame body or the like, a wiring conductor, or the like.

A method for producing the laminated glass 10 according to the embodiment of the present invention may be the same as that for a known laminated glass in the related art. For example, through a step of laminating the first glass plate 11, the interlayer 13, and the second glass plate 12 in this order and performing heating and pressing, the laminated glass 10 having a configuration in which the first glass plate 11 and the second glass plate 12 are bonded via the interlayer 13 is obtained.

In the method for producing the laminated glass 10 according to the embodiment of the present invention, for example, after a step of heating and forming each of the first glass plate 11 and the second glass plate 12, a step of inserting the interlayer 13 between the first glass plate 11 and the second glass plate 12 and performing heating and pressing may be performed. Through such steps, the laminated glass 10 having the configuration in which the first glass plate 11 and the second glass plate 12 are bonded via the interlayer 13 may be obtained.

In the laminated glass 10 according to the embodiment of the present invention, a total thickness of the first glass plate 11, the second glass plate 12, and the interlayer 13 is 6.00 mm or less, and a visible light transmittance Tv defined by ISO-9050:2003 using a D65 light source is preferably 70.0% or more, more preferably 71.0% or more, still more preferably 72.0% or more, and particularly preferably 75.0% or more. In addition, the visible light transmittance Tv is, for example, 80.0% or less. Note that, at this time, the first glass plate 11 and the second glass plate 12 may each have a thickness of 2.00 mm. Further, the total thickness of the first glass plate 11, the second glass plate 12, and the interlayer 13 may be 2.50 mm or more, 3.00 mm or more, 3.50 mm or more, 4.00 mm or more, or 4.50 mm or more.

In the laminated glass 10 according to the embodiment of the present invention, the total thickness of the first glass plate 11, the second glass plate 12, and the interlayer 13 is 6.00 mm or less, and a total solar transmittance Tts defined by ISO-13837:2008 convention A and measured at a wind speed of 4 m/s is preferably 75.0% or less. When the total solar transmittance Tts of the laminated glass 10 according to the embodiment of the present invention is 75.0% or less, a sufficient heat shielding property is obtained. The above total solar transmittance Tts is more preferably 70.0% or less, still more preferably 68.0% or less, and particularly preferably 66.0% or less. In addition, the above total solar transmittance Tts is, for example, 50.0% or more. Note that, at this time, the first glass plate 11 and the second glass plate 12 may each have a thickness of 2.00 mm. Further, the total thickness of the first glass plate 11, the second glass plate 12, and the interlayer 13 may be 2.50 mm or more, 3.00 mm or more, 3.50 mm or more, 4.00 mm or more, or 4.50 mm or more.

### [Window Glass for Vehicle]

A window glass for a vehicle according to the present embodiment includes the above borosilicate glass or the above bent glass. The window glass for a vehicle according to the present embodiment may be made of the above laminated glass.

Hereinafter, an example in which the laminated glass 10 according to the present embodiment is used as a window glass for a vehicle will be described with reference to the drawings.

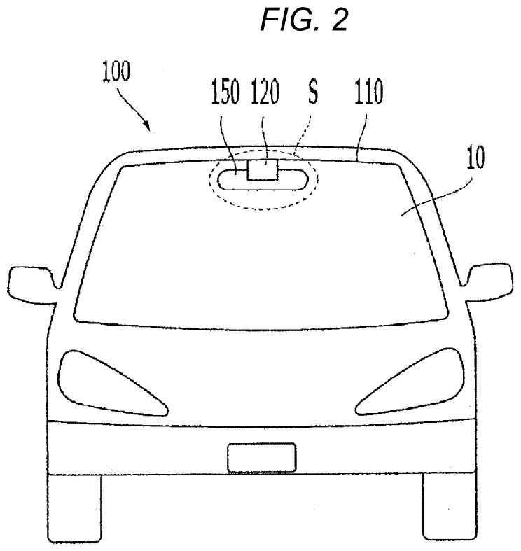

FIG. 2 is a conceptual diagram illustrating a state in which the laminated glass 10 according to the present embodiment is mounted on an opening 110 formed at a front part of an automobile 100 and used as an automobile window glass. In the laminated glass 10 used as the automobile window glass, a housing (case) 120 in which an information device or the like is housed for ensuring traveling safety of the vehicle may be attached to a surface on an inner side of the vehicle.

The information device housed in the housing is a device that uses a camera, a radar, or the like to prevent rear-end collision or collision with a preceding vehicle, a pedestrian, an obstacle, or the like in front of the vehicle or to notify a driver of a danger. For example, the information device is an information receiving device and/or an information transmitting device, includes a millimeter wave radar, a stereo camera, an infrared laser, or the like, and transmits and receives a signal. The “signal” is an electromagnetic wave including a millimeter wave, visible light, or infrared light.

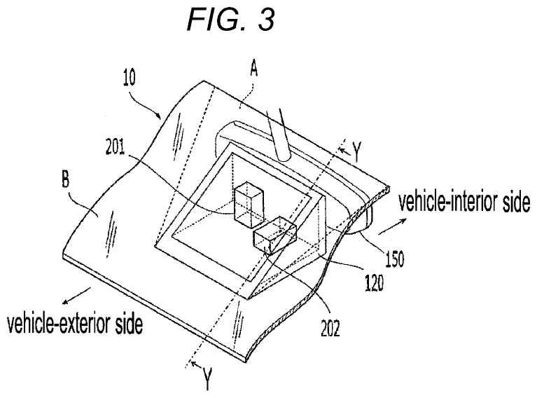

FIG. 3 is an enlarged view of a portion S in FIG. 2, and is a perspective view illustrating a portion where the housing 120 is attached to the laminated glass 10 according to the present embodiment. The housing 120 houses a millimeter wave radar 201 and a stereo camera 202 as the information device. The housing 120 in which the information device is housed is generally attached to a vehicle-exterior side with respect to a back mirror 150 and a vehicle-interior side with respect to the laminated glass 10, or may be attached to another portion.

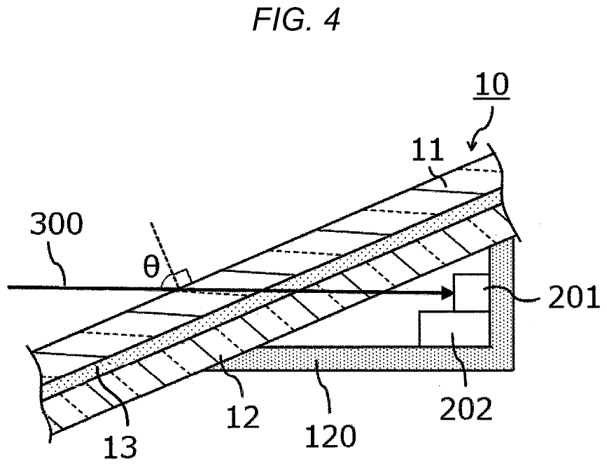

FIG. 4 is a cross-sectional view including a line Y-Y in FIG. 3 in a direction orthogonal to a horizontal line. The first glass plate 11 of the laminated glass 10 is disposed on the vehicle-exterior side. Note that, as described above, an incident angle θ of a radio wave 300 used for communication of the information device such as the millimeter wave radar 201 with respect to a main surface of the first glass plate 11 can be evaluated as, for example, 0° to 60° as described above.

### EXAMPLES

Hereinafter, the present invention will be specifically described with reference to

Examples, but the present invention is not limited thereto.

Raw materials were charged into a platinum crucible so as to obtain a glass composition (unit: mol %) shown in Table 1, and melted at 1650° C. for 3 hours to obtain each molten glass. The molten glass was poured onto a carbon plate and slowly cooled. Both surfaces of the obtained plate-shaped glass were polished to obtain each of plate-shaped glass A to glass L having a thickness of 1.50 mm. Here, the glass A and the glass B are Comparative Examples, and the glass C to the glass L are Inventive Examples.

Next, the glass A to the glass L were subjected to bending under the following conditions to prepare bent glasses in Example 1 to Example 12 shown in Table 2.

Each of the flat glasses (the glass A to the glass L) having a thickness of 1.50 mm was carried into an electric furnace, maintained at a heating temperature of 630° C. (T₁₂ or higher in each of the flat glasses), pressed using a mold having a curved surface, and held in the pressed state for 6 minutes to subject to bending and forming. Thereafter, the press was released, the shape of the bent glass was maintained, and cooling air was blown onto the glass for cooling.

Methods for determining numerical values shown in Table 1 and Table 2 are shown below.

(1) Density: The density of about 20 g of a glass mass containing no foam and cut out from the glass plate was measured with Archimedes method.

### (2) Relative Dielectric Constant (εᵣ) and Dielectric Loss Tangent (tan δ):

The relative dielectric constant (εᵣ) and the dielectric loss tangent (tan δ) at a frequency of 10 GHz were measured under the condition of 1° C./min slow cooling with a split post dielectric resonator (manufactured by QWED Company) method (SPDR method).

(3) Viscosity (T₁₁, T₁₂, and T_{g}):

The temperature T₁₁ at which the viscosity η was 10¹¹ dPa·s and the temperature T₁₂ at which the viscosity η was 10¹² dPa·s were measured with a beam bending method. In addition, the glass transition point (T_{g}) was a value measured using TMA and was determined based on the standard in JIS R3103-3 (2001).

### (4) Average Linear Expansion Coefficient at 50° C. to 350° C. (CTE_50° C. to 350° C.):

The average thermal expansion coefficient was measured using a differential thermal dilatometer (TMA) and was determined based on the standard in JIS R3102 (1995).

### (5) Optical Properties:

Transmission and reflection spectra of a light having a wavelength of 200 nm to 2500 nm were measured using a spectrophotometer LAMBDA 950 manufactured by Perkinelmer, and a transmittance of a light having a wavelength of 500 nm, a transmittance of a light having a wavelength of 1000 nm, an average transmittance of a light having a wavelength of 450 nm to 700 nm, and an average transmittance of a light having a wavelength of 900 nm to 1300 nm were determined based on ISO9050:2003. Note that, the average transmittance of a light having a wavelength of 900 nm to 1300 nm was measured both before bending (T_{b}) and after bending (Tₐ).

### (6) Redox (Fe-Redox):

[Fe²⁺]/([Fe²⁺]+[Fe³⁺]) was obtained based on the method described in the present description.

### (7) Visible Light Transmittance (Tv1 and Tv2):

The visible light transmittance Tv1 of the glass plate before bending and the visible light transmittance Tv2 of the glass plate after bending when the thickness was converted to 1.50 mm were measured using a D65 light source according to the method specified in ISO-9050:2003. Note that, Tv1 and Tv2 were measured using a spectrophotometer LAMBDA 950 manufactured by Perkinelmer.

### (8) Total Solar Transmittance (Tts1 and Tts2):

The total solar transmittance Tts1 of the glass plate before bending and the total solar transmittance Tts2 of the glass plate after bending when the thickness was converted to 1.50 mm were defined by ISO-13837:2008 convention A and were measured by a method performed at a wind speed of 4 m/s. Note that, Tts was measured using a spectrophotometer LAMBDA 950 manufactured by Perkinelmer.

### (9) SAXS Measurement:

The SAXS measurement of the glass A and the glass E before and after bending was performed under the following conditions.
Wavelength: 0.92 Å
Measurement detector: PILATUS
Measurement time: 480 sec
Measurement camera length: 2174.4 mm

The obtained scattering intensity was converted to per unit thickness [mm], and absolute intensity correction was performed using an absolute intensity correction sample SRM 3600. The corrected scattering intensity was plotted with respect to the scattering vector q. Then, the rate of change in the maximum value (1−(Sₐ/S_{b})) before and after the bending and forming was measured.

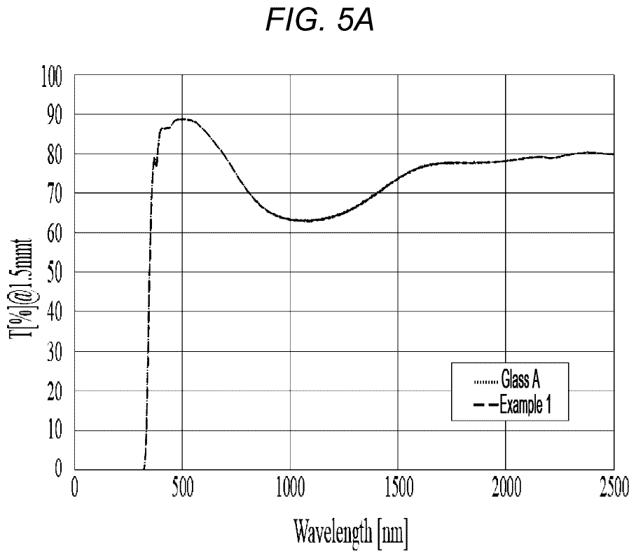

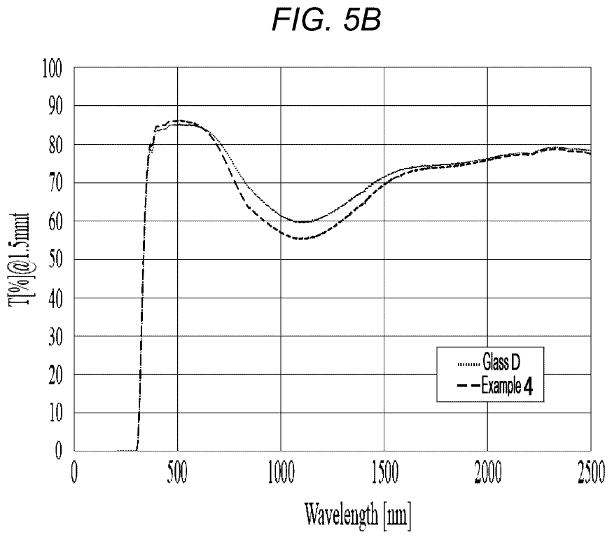

The measurement results are shown in Table 1 and Table 2. Regarding the glass A and the glass D, the measurement results of transmission spectra of a light having a wavelength of 200 nm to 2500 nm before and after bending are shown in FIGS. 5A and 5B, and the SAXS results are shown in FIG. 6.

TABLE 1

| mol % | A | B | C | D | E | F |
|---|---|---|---|---|---|---|
| SiO₂ | 69.5 | 83.4 | 77.6 | 80.5 | 83.4 | 83.3 |
| Al₂O₃ | 0.9 | 1.2 | 1.5 | 1.8 | 1.2 | 1.2 |
| B₂O₃ | 0.0 | 11.6 | 13.5 | 11.0 | 11.5 | 11.5 |
| MgO | 7.1 | 0.0 | 0.0 | 0.0 | 0.0 | 0.0 |
| CaO | 9.1 | 0.0 | 0.0 | 0.0 | 0.0 | 0.0 |
| SrO | 0.0 | 0.0 | 0.0 | 0.0 | 0.0 | 0.0 |
| BaO | 0.0 | 0.0 | 0.0 | 0.0 | 0.0 | 0.0 |
| Li₂O | 0.0 | 0.0 | 2.4 | 2.2 | 0.0 | 0.0 |
| Na₂O | 12.6 | 3.3 | 2.4 | 2.2 | 3.3 | 3.3 |
| K₂O | 0.6 | 0.5 | 2.4 | 2.2 | 0.5 | 0.5 |
| Fe₂O₃ | 0.185 | 0.020 | 0.194 | 0.192 | 0.101 | 0.193 |
| [SiO₂] + [Al₂O₃] + [B₂O₃] | 70.4 | 96.2 | 92.6 | 93.2 | 96.1 | 96.1 |
| [Fe²⁺]/([Fe²⁺] + [Fe³⁺]) | 0.20 | 0.32 | 0.27 | 0.55 | 0.25 | 0.58 |
| [Al₂O₃]/([SiO₂] + [B₂O₃]) | 0.0129 | 0.0126 | 0.0165 | 0.0197 | 0.0128 | 0.0128 |
| Density (g/cm³) | 2.50 | 2.23 | 2.28 | 2.27 | 2.21 | 2.21 |
| εᵣ at 10 GHz | 6.71 | 4.46 | 4.85 | 4.82 | ≤6.00 | ≤6.00 |
| tan δ at 10 GHz | 0.0122 | 0.0080 | 0.0065 | 0.0069 | ≤0.010 | ≤0.010 |
| T_{g} (° C.) | 549 | 525 | 494 | 517 | 526 | 527 |
| CTE_50° C. to 350° C. | 91 | 33 | 43 | 41 | 33 | 32 |
| (×10⁻⁷/K) | | | | | | |
| Young's modulus (GPa) | 74 | 61 | 69 | 69 | 62 | 62 |
| T₁₁ (° C.) | 613 | 650 | 637 | 652 | 651 | 653 |
| T₁₂ (° C.) | 590 | 609 | 607 | 625 | 610 | 613 |
| Transmittance at 500 nm, | 88.6 | 92.6 | 85.8 | 85.2 | 88.5 | 77.8 |
| 1.5 mmt (%) | | | | | | |
| Transmittance at 1000 nm, | 63.2 | 92.6 | 77.0 | 61.5 | 87.2 | 81.8 |
| 1.5 mmt (%) | | | | | | |
| Average transmittance at | 86.0 | 92.6 | 86.1 | 84.3 | 89.0 | 80.8 |
| 450 nm to 700 nm (%) | | | | | | |
| Average transmittance at | 64.0 | 92.6 | 77.1 | 61.6 | 86.8 | 79.1 |
| 900 nm to 1300 nm (%) | | | | | | |
| mol % | G | H | I | J | K | L |
| SiO₂ | 83.3 | 83.2 | 83.1 | 75.4 | 77.9 | 74.8 |
| Al₂O₃ | 1.2 | 1.2 | 1.2 | 1.0 | 3.0 | 4.0 |
| B₂O₃ | 11.5 | 11.6 | 11.5 | 14.0 | 10.5 | 13.5 |
| MgO | 0.0 | 0.0 | 0.0 | 0.0 | 0.0 | 0.0 |
| CaO | 0.0 | 0.0 | 0.0 | 2.0 | 0.0 | 0.0 |
| SrO | 0.0 | 0.0 | 0.0 | 0.0 | 0.0 | 0.0 |
| BaO | 0.0 | 0.0 | 0.0 | 0.0 | 0.0 | 0.0 |
| Li₂O | 0.0 | 0.0 | 0.0 | 2.5 | 1.5 | 3.3 |
| Na₂O | 3.3 | 3.3 | 3.3 | 2.5 | 6.2 | 3.9 |
| K₂O | 0.5 | 0.5 | 0.5 | 2.5 | 0.66 | 0.30 |
| Fe₂O₃ | 0.193 | 0.290 | 0.386 | 0.193 | 0.194 | 0.194 |
| [SiO₂] + [Al₂O₃] + [B₂O₃] | 96.1 | 95.9 | 95.8 | 90.3 | 91.4 | 92.3 |
| [Fe²⁺]/([Fe²⁺] + [Fe³⁺]) | 0.58 | 0.21 | 0.21 | 0.24 | 0.24 | 0.27 |
| [Al₂O₃]/([SiO₂] + [B₂O₃]) | 0.0128 | 0.0126 | 0.0126 | 0.0112 | 0.0339 | 0.0452 |
| Density (g/cm³) | 2.21 | 2.21 | 2.21 | 2.31 | 2.31 | 2.25 |
| εᵣ at 10 GHz | ≤6.00 | ≤6.00 | ≤6.00 | 4.96 | 5.22 | 4.88 |
| tan δ at 10 GHz | ≤0.010 | ≤0.010 | ≤0.010 | 0.0072 | 0.0099 | 0.0081 |
| T_{g} (° C.) | 527 | 527 | 528 | 525 | 529 | 498 |
| CTE_50° C. to 350° C. | 32 | 32 | 31 | 48 | 49 | 44 |
| (×10⁻⁷/K) | | | | | | |
| Young's modulus (GPa) | 62 | 61 | 61 | 73 | 72 | 66 |
| T₁₁ (° C.) | 653 | 653 | 654 | 641 | 587 | 588 |
| T₁₂ (° C.) | 613 | 613 | 614 | 597 | 556 | 557 |
| Transmittance at 500 nm, | 77.6 | 63.4 | 47.5 | 88.3 | 86.2 | 79.4 |
| 1.5 mmt (%) | | | | | | |
| Transmittance at 1000 nm, | 63.9 | 75.7 | 69.6 | 77.1 | 73.3 | 79.5 |
| 1.5 mmt (%) | | | | | | |
| Average transmittance at | 78.8 | 66.2 | 51.3 | 88.0 | 85.9 | 81.0 |
| 450 nm to 700 nm (%) | | | | | | |
| Average transmittance at | 63.5 | 75.9 | 70.7 | 77.2 | 73.6 | 79.2 |
| 900 nm to 1300 nm (%) | | | | | | |

TABLE 2

| | Example | Example | Example | Example | Example | Example |
|---|---|---|---|---|---|---|
| | 1 | 2 | 3 | 4 | 5 | 6 |
| Glass | A | B | C | D | E | F |
| T_{b}_{_{—}}ave. at 900 | 64.0 | 92.6 | 77.1 | 61.6 | 86.8 | 79.1 |
| nm to 1300 nm | | | | | | |
| Tₐ_{_{—}}ave. at 900 | 64.1 | 92.7 | 74.9 | 57.3 | 85.2 | 75.9 |
| nm to 1300 nm | | | | | | |
| T_{b} − Tₐ | −0.02 | −0.06 | 2.19 | 4.34 | 1.64 | 3.14 |
| Tv1 | 87.54 | 92.64 | 86.22 | 84.94 | 88.86 | 78.72 |
| Tv2 | 87.60 | 92.80 | 86.69 | 85.50 | 89.35 | 80.36 |
| Tv1 − Tv2 | −0.1 | −0.2 | −0.5 | −0.6 | −0.5 | −1.6 |
| Tts1 | 83.08 | 94.64 | 87.05 | 82.44 | 91.18 | 85.48 |
| Tts2 | 83.05 | 94.73 | 86.60 | 81.23 | 90.95 | 85.58 |
| Tts1 − Tts2 | 0.03 | −0.09 | 0.45 | 1.21 | 0.23 | −0.10 |
| (Tts1 − Tts2)/(Tts1) | 0.000 | −0.001 | 0.005 | 0.015 | 0.002 | −0.001 |
| | Example | Example | Example | Example | Example | Example |
| | 7 | 8 | 9 | 10 | 11 | 12 |
| Glass | G | H | I | J | K | L |
| T_{b}_{_{—}}ave. at 900 | 63.5 | 75.9 | 70.7 | 77.2 | 73.6 | 79.2 |
| nm to 1300 nm | | | | | | |
| Tₐ_{_{—}}ave. at 900 | 57.5 | 73.0 | 67.1 | 75.4 | 72.7 | 77.8 |
| nm to 1300 nm | | | | | | |
| T_{b} − Tₐ | 6.02 | 2.93 | 3.54 | 1.83 | 0.92 | 1.44 |
| Tv1 | 78.74 | 64.98 | 49.59 | 88.38 | 86.28 | 80.48 |
| Tv2 | 80.88 | 68.24 | 54.09 | 87.71 | 86.80 | 82.30 |
| Tv1 − Tv2 | −2.1 | −3.3 | −4.5 | 0.7 | −0.5 | −1.8 |
| Tts1 | 80.72 | 78.43 | 70.77 | 87.59 | 86.05 | 85.31 |
| Tts2 | 79.68 | 79.07 | 71.89 | 86.64 | 85.86 | 85.70 |
| Tts1 − Tts2 | 1.04 | −0.64 | −1.12 | 0.95 | 0.19 | −0.4 |
| (Tts1 − Tts2)/(Tts1) | 0.013 | −0.008 | −0.016 | 0.011 | 0.002 | −0.005 |

It can be seen that the glass C to the glass L, i.e., borosilicate glasses, have T_{b}−Tₐ of more than 0, and can have an improved heat shielding property in the case of being formed into a bent glass. In addition, according to FIG. 5B, it can be seen that in the glass D, the average transmittance of a light having a wavelength of 900 nm to 1300 nm changes before and after bending.

In addition, it can be seen that in the glass C to the glass L, i.e., borosilicate glasses, the transmittance of a light having a wavelength of 1000 nm and the average transmittance of a light having a wavelength of 900 nm to 1300 nm when the thickness is 1.50 mm are 90% or less, and a near-infrared light transmittance is low, so that a good heat shielding property is obtained.

In addition, in the glass C to the glass L, i.e., borosilicate glasses, the relative dielectric constant (εᵣ) at a frequency of 10 GHz is 6.0 or less, and the dielectric loss tangent (tan δ) at a frequency of 10 GHz is 0.010 or less, so that a good radio wave transmissibility is exhibited. In this way, it can be seen that the glass C to the glass L, i.e., borosilicate glasses, have a high millimeter wave transmissibility, satisfy a predetermined heat shielding property, and have a certain visible light transmittance.

On the other hand, it can be seen that the glass A to the glass B, i.e., borosilicate glasses, have T_{b}−Tₐ of 0 or less, and cannot sufficiently improve the heat shielding property in the case of being formed into a bent glass.

In addition, according to FIG. 6 showing the SAXS results, in the glass A before bending, the maximum value of the scattering intensity in the range of the scattering vector q of 0.10 to 2.0 (nm⁻¹) is 0.34, which is less than 0.35. On the other hand, in the glass D before bending, the maximum value of the scattering intensity in the range of the scattering vector q of 0.10 to 2.0 (nm⁻¹) is 12.5, which is 0.35 or more. Further, when the glass D is subjected to bending and forming, a reduction in scattering intensity is observed (Example 4), and the rate of change in the above maximum value 1−(Sₐ/S_{b}) before and after the bending and forming is 0.87. Accordingly, it is considered that, in the glass D, the bending and forming causes a structural change in the glass, resulting in a reduction in heterogeneous structure, and the average transmittance of a light having a wavelength of 900 nm to 1300 nm is reduced, so that a bent glass having an improved heat shielding property is obtained.

Although various embodiments have been described above with reference to the drawings, it is needless to say that the present invention is not limited to such examples. It is obvious for a person skilled in the art that various modifications and variations can be made within the category described in the scope of claims and it is understood that such modifications and variations naturally belong to the technical scope of the present invention. Further, the components described in the above embodiment may be combined in any manner without departing from the spirit of the invention.

Note that the present application is based on Japanese Patent Application No. 2021-175915 filed on Oct. 27, 2021, contents of which are incorporated herein by reference.

### REFERENCE SIGNS LIST

10 laminated glass
11 first glass plate
12 second glass plate
13 interlayer
100 automobile
110 opening
120 housing
150 back mirror
201 millimeter wave radar
202 stereo camera
300 radio wave

What is claimed is:

1. A borosilicate glass comprising:
in mol % in terms of oxide,
70.0%≤SiO₂≤85.0%;
5.0%≤B₂O₃≤20.0%;
0.70%≤Al₂O₃≤10.0%;
0.0%≤Li₂O≤5.0%;
0.0%≤Na₂O≤10.0%;
0.0%≤K₂O≤5.0%;
0.0%≤MgO≤5.0%;
0.0%≤CaO≤5.0%;
0.0%≤SrO≤5.0%; and
0.10%≤Fe₂O₃<1.0%, wherein
the borosilicate glass has a total amount of SiO₂, Al₂O₃, and B₂O₃ of 85.0% or more,
the borosilicate glass is substantially free of BaO, PbO, and As₂O₃, and
T_{b}−Tₐ >O is satisfied where T_{b}[%] is an average transmittance of a light having a wavelength of 900 nm to 1300 nm when the borosilicate glass is a flat glass and a thickness of the flat glass is converted to 1.50 mm, and Tₐ[%] is an average transmittance of the light having a wavelength of 900 nm to 1300 nm when the thickness is converted to 1.50 mm in a case where the flat glass is heated and bent at a temperature equal to or higher than a temperature T₁₂ at which a glass viscosity is 10¹² [dPa·s].

2. A borosilicate glass comprising:
in mol % in terms of oxide,
70.0%≤SiO₂≤85.0%;
5.0%≤B₂O₃≤20.0%;
0.70%≤Al₂O₃≤10.0%;
0.0%≤Li₂O≤5.0%;
0.0%≤Na₂O≤10.0%;
0.0%≤K₂O≤5.0%;
0.0%≤MgO≤5.0%;
0.0%≤CaO≤5.0%;
0.0%≤SrO≤5.0%; and
0.10%≤Fe₂O₃≤1.0%, wherein
the borosilicate glass has a total amount of SiO₂, Al₂O₃, and B₂O₃ of 85.0% or more,
the borosilicate glass is substantially free of BaO, PbO, and As₂O₃, and
T_{b}−Tₐ>0 is satisfied where T_{b} [%] is an average transmittance of a light having a wavelength of 900 nm to 1300 nm when the borosilicate glass is a flat glass and a thickness of the flat glass is converted to 1.50 mm, and Tₐ [%] is an average transmittance of the light having a wavelength of 900 nm to 1300 nm when the flat glass is heated to 630° C., a bending time is 6 minutes, and the thickness is converted to 1.50 mm.

3. A borosilicate glass comprising:
in mol % in terms of oxide,
70.0%≤SiO₂≤85.0%;
5.0%≤B₂O₃≤20.0%;
0.70%≤Al₂O₃≤10.0%;
0.0%≤Li₂O≤5.0%;
0.0%≤Na₂O≤10.0%;
0.0%≤K₂O≤5.0%;
0.0%≤MgO≤5.0%;
0.0%≤CaO≤5.0%;
0.0%≤SrO≤5.0%; and
0.10%≤Fe₂O₃≤1.0%, wherein
the borosilicate glass has a total amount of SiO₂, Al₂O₃, and B₂O₃ of 85.0% or more,
the borosilicate glass is substantially free of BaO, PbO, and As₂O₃,
a maximum value of a normalized scattering intensity in a range of a scattering vector q of 0.10 to 2.0 (nm⁻¹) by small-angle X-ray scattering (SAXS) measurement is 0.35 or more when the borosilicate glass is a flat glass, and
the maximum value of the normalized scattering intensity in the range of the scattering vector q of 0.10 to 2.0 (nm⁻¹) by the SAXS measurement is reduced in a case where the flat glass is heated and bent at a temperature equal to or higher than a temperature T₁₂ at which a glass viscosity is 10¹² [dPa·s].

4. The borosilicate glass according to claim 1, wherein (Tts1−Tts2)/Tts1≥ 0.002 is satisfied, where
Tts1 is a total solar transmittance defined by ISO-13837:2008 convention A and measured at a wind speed of 4 m/s when the borosilicate glass is a flat glass and a thickness of the flat glass is converted to 1.50 mm, and
Tts2 is a total solar transmittance defined by ISO-13837:2008 convention A and measured at a wind speed of 4 m/s when the thickness is converted to 1.50 mm in a case where the flat glass is heated and bent at a temperature equal to or higher than the temperature T₁₂ at which the glass viscosity is 10¹² [dPa·s].

5. The borosilicate glass according to claim 1, being a float glass.

6. The borosilicate glass according to claim 1, being a fusion draw glass.

7. The borosilicate glass according to claim 1, wherein the temperature T₁₂ at which the glass viscosity is 10¹² [dPa·s] is 650° C. or lower.

8. The borosilicate glass according to claim 1, being substantially free of Er₂O₃.

9. The borosilicate glass according to claim 1, having a transmittance of a light having a wavelength of 500 nm of 78.0% or more when a thickness of the borosilicate glass is converted into 1.50 mm.

10. The borosilicate glass according to claim 1, having a transmittance of a light having a wavelength of 1000 nm of 90.0% or less when a thickness of the borosilicate glass is converted into 1.50 mm.

11. The borosilicate glass according to claim 1, having an average transmittance of a light having a wavelength of 450 nm to 700 nm of 78.0% or more when a thickness of the borosilicate glass is converted into 1.50 mm.

12. The borosilicate glass according to claim 1, having an average transmittance of a light having a wavelength of 900 nm to 1300 nm of 90.0% or less when a thickness of the borosilicate glass is converted into 1.50 mm.

13. The borosilicate glass according to claim 1, wherein the content of Fe₂O₃ is 0.15% or more in mol % in terms of oxide.

14. A bent glass comprising:
the borosilicate glass according to claim 1.

15. The bent glass according to claim 14, being a single bent glass.

16. The bent glass according to claim 14, being a multi-bent glass.

17. The bent glass according to claim 14, having a minimum radius of curvature of 500 mm or more and 100,000 mm or less.

18. The bent glass according to claim 14, having a total solar transmittance defined by ISO-13837:2008 convention A and measured at a wind speed of 4 m/s of 90% or less when a thickness of the bent glass is converted into 1.50 mm.

19. A method for producing a bent glass, comprising:
heating the borosilicate glass according to claim 1 to form a bent glass.

20. A laminated glass comprising:
a first glass plate;
a second glass plate; and
an interlayer sandwiched between the first glass plate and the second glass plate,
wherein
at least one of the first glass plate and the second glass plate is the borosilicate glass according to claim 1.

21. The laminated glass according to claim 20, wherein the first glass plate, the second glass plate, and the interlayer have a total thickness of 6.00 mm or less, and
the laminated glass has a visible light transmittance Tv defined by ISO-9050:2003 using a D65 light source of 70% or more.

22. A window glass for a vehicle comprising:
the borosilicate glass according to claim 1.

23. A window glass for a vehicle comprising:
the laminated glass according to claim 20.
